(19) United States
(12) Patent Application Publication
(10) Pub. No.: US 2016/0127728 A1
(43) Pub. Date: May 5, 2016

(54) VIDEO COMPRESSION APPARATUS, VIDEO PLAYBACK APPARATUS AND VIDEO DELIVERY SYSTEM

(71) Applicant: KABUSHIKI KAISHA TOSHIBA, Minato-ku (JP)

(72) Inventors: Akiyuki TANIZAWA, Kawasaki (JP); Tomoya Kodama, Kawasaki (JP)

(73) Assignee: KABUSHIKI KAISHA TOSHIBA, Minato-ku (JP)

(21) Appl. No.: 14/927,863

(22) Filed: Oct. 30, 2015

(30) Foreign Application Priority Data
Oct. 30, 2014 (JP) 2014-221617

(51) Int. Cl. H04N 19/114; H04N 19/70; H04N 19/30; H04N 19/426; H04N 19/136; H04N 19/503; H04N 19/44; H04N 19/85

(52) U.S. Cl. CPC H04N 19/114; H04N 19/44; H04N 19/70; H04N 19/85; H04N 19/426; H04N 19/136; H04N 19/503; H04N 19/30

(57) ABSTRACT

According to an embodiment, a video compression apparatus includes a controller. The controller controls, based on a first random access point included in the first bitstream, a second random access point included in a second bitstream corresponding to compressed data of the second video. The second bitstream is formed from a plurality of picture groups. Each of the plurality of picture groups includes at least one picture subgroup. The controller selects, from the second bitstream, an earliest picture subgroup on or after the first random access point in display order and sets an earliest picture of the selected picture subgroup in coding order as the second random access point.

### CROSS-REFERENCE TO RELATED APPLICATIONS

This application is based upon and claims the benefit of priority from Japanese Patent Application No. 2014-221617, filed Oct. 30, 2014, the entire contents of which are incorporated herein by reference.

### FIELD

Embodiments described herein relate generally to video compression and video playback.

### BACKGROUND

Recently, as one of moving picture compression standards, ITU-T REC. H.265 and ISO/IEC 23008-2 (to be referred to as “HEVC” hereinafter) has been recommended. HEVC attains a compression efficiency approximately four times higher than that of ITU-T Rec. H.262 and ISO/IEC 13818-2 (to be referred to as “MPEG-2” hereinafter) and a compression efficiency approximately twice higher than that of ITU-T REC. H.264 and ISO/IEC 14496-10 (to be referred to as “H.264” hereinafter).

In H.264, a scalable compression function (to be referred to as “SVC” hereinafter) called H.264 Scalable Extension has been introduced. If a video is hierarchically compressed using SVC, a video playback apparatus can change the image quality, resolution, or frame rate of a playback video by changing a bitstream to be reproduced. Additionally, in ITU-T and ISO/IEC, examination has been done to introduce the same scalable compression function (to be referred to as “SHVC” hereinafter) as in SVC to the above-described HEVC.

In the scalable compression function represented by SVC and SHVC, a video is layered into a base layer and at least one enhancement layer, and the video of each enhancement layer is predicted based on the video of the base layer. It is therefore possible to compress videos in a number of layers while suppressing redundancy of enhancement layers. The scalable compression function is useful in, for example, video delivery technologies such as video monitoring, video conferencing, video phones, broadcasting, and video streaming delivery. When a network is used for video delivery, the bandwidth of a channel may vary every moment. At the time of such network utilization, using scalable compression, the base layer video with a low bit rate is always transmitted, and the enhancement layer video is transmitted when the bandwidth has a margin, thereby enabling efficient video delivery independently of the above-described temporal change in the bandwidth. Alternatively, at the time of such network utilization, compressed videos having a plurality of bit rates can be created in parallel (to be referred to as “simultaneous compression” hereinafter) instead of using scalable compression and selectively transmitted in accordance with the bandwidth.

An H.264 codec needs to be used in both the base layer and the enhancement layer. On the other hand, SHVC implements hybrid scalable compression capable of using an arbitrary codec in the base layer. According to hybrid scalable compression, compatibility with an existing video device can be ensured. For example, when MPEG (Moving Picture Experts Group)-2 is used in the base layer, and SHVC is used in the enhancement layer, compatibility with a video device using MPEG-2 can be ensured.

However, when different codecs are used in the base layer and the enhancement layer, prediction structures (for example, coding orders and random access points) do not necessarily match between the codecs. If the random access points do not match between the base layer and the enhancement layer, the random accessibility of the enhancement layer degrades. If the picture coding orders do not match between the base layer and the enhancement layer, a playback delay increases. On the other hand, to make the prediction structure of the enhancement layer match that of the base layer, analysis processing of the prediction structure of the base layer and change processing of the prediction structure of the enhancement layer according to the analysis result are needed. Hence, additional hardware or software for these processes increases the device cost, and the playback delay of the enhancement layer increases in accordance with the processing time. Furthermore, since usable prediction structures are limited, the compression efficiency of the enhancement layer lowers.

### BRIEF DESCRIPTION OF THE DRAWINGS

FIG. 1 is a block diagram showing a video delivery system according to the first embodiment;

FIG. 2 is a block diagram showing a video compression apparatus in FIG. 1;

FIG. 3 is a block diagram showing a video converter in FIG. 2;

FIG. 4 is a block diagram showing a video reverse-converter in FIG. 2;

FIG. 5 is a view showing the prediction structure of a first bitstream;

FIG. 6 is a view showing the prediction structure of a first bitstream;

FIG. 7 is an explanatory view of a case where a first bitstream and a second bitstream have the same prediction structure;

FIG. 8 is an explanatory view of a case where a first bitstream and a second bitstream have the same prediction structure;

FIG. 9 is an explanatory view of a case where a first bitstream and a second bitstream have different prediction structures;

FIG. 10 is an explanatory view of a case where a first bitstream and a second bitstream have different prediction structures;

FIG. 11 is an explanatory view of a case where a first bitstream and a second bitstream have different prediction structures;

FIG. 12 is an explanatory view of prediction structure control processing performed by a prediction structure controller shown in FIG. 2;

FIG. 13 is an explanatory view of a modification of FIG. 12;

FIG. 14 is a view showing first prediction structure information used by the prediction structure controller in FIG. 2;

FIG. 15 is a view showing second prediction structure information generated by the prediction structure controller in FIG. 2;

FIG. 16 is a block diagram showing a data multiplexer in FIG. 2;

FIG. 17 is a view showing the data format of a PES packet that forms a multiplexed bitstream generated by the data multiplexer in FIG. 16;

FIG. 18 is a flowchart showing the operation of the video converter in FIG. 3;

FIG. 19 is a flowchart showing the operation of the video reverse-converter in FIG. 4;

FIG. 20 is a flowchart showing the operation of the decoder in FIG. 2;

FIG. 21 is a flowchart showing the operation of the prediction structure controller in FIG. 2;

FIG. 22 is a flowchart showing the operation of a compressor included in a second video compressor in FIG. 2;

FIG. 23 is a block diagram showing a video delivery system according to the second embodiment;

FIG. 24 is a block diagram showing a video compression apparatus in FIG. 23;

FIG. 25 is a block diagram showing a video playback apparatus in FIG. 1;

FIG. 26 is a block diagram showing a data multiplexer in FIG. 25;

FIG. 27 is a block diagram showing a video playback apparatus in FIG. 23;

FIG. 28 is a block diagram showing the compressor incorporated in the second video compressor in FIG. 2;

FIG. 29 is a block diagram showing a spatiotemporal correlation controller in FIG. 28;

FIG. 30 is a block diagram showing a predicted image generator in FIG. 28; and

FIG. 31 is a block diagram showing a decoder incorporated in a second video compressor in FIG. 23.

### DETAILED DESCRIPTION

Embodiments will now be described with reference to the accompanying drawings.

According to an embodiment, a video compression apparatus includes a first compressor, a controller and a second compressor. The first compressor compresses, out of a first video and a second video that are layered, the first video using a first codec to generate a first bitstream. The controller controls, based on a first random access point included in the first bitstream, a second random access point included in a second bitstream corresponding to compressed data of the second video. The second compressor compresses the second video using a second codec different from the first codec based on a first decoded video corresponding to the first video to generate the second bitstream. The second bitstream is formed from a plurality of picture groups. Each of the plurality of picture groups includes at least one picture subgroup. The controller selects, from the second bitstream, an earliest picture subgroup on or after the first random access point in display order and sets an earliest picture of the selected picture subgroup in coding order as the second random access point.

According to another embodiment, a video playback apparatus includes a first decoder and a second decoder. The first decoder decodes, using a first codec, a first bitstream corresponding to compressed data of a first video out of the first video and a second video that are layered, to generate a first decoded video. The second decoder decodes a second bitstream corresponding to compressed data of the second video using a second codec different from the first codec based on the first decoded video to generate a second decoded video. The second bitstream is formed from a plurality of picture groups. Each of the plurality of picture groups includes at least one picture subgroup. The first bitstream includes a first random access point. The second bitstream includes a second random access point. The second random access point is set to an earliest picture of a particular picture subgroup in coding order. The particular picture subgroup is an earliest picture subgroup on or after the first random access point in display order.

According to another embodiment, a video delivery system includes a video storage apparatus, a video compression apparatus, a video transmission apparatus, a video receiving apparatus, a video playback apparatus and a display apparatus. The video storage apparatus stores and reproduces a baseband video. The video compression apparatus scalably-compresses a first video and a second video in which the baseband video is layered, to generate a first bitstream and a second bitstream. The video transmission apparatus transmits the first bitstream and the second bitstream via at least one channel. The video receiving apparatus receives the first bitstream and the second bitstream via the at least one channel. The video playback apparatus scalably-decodes the first bitstream and the second bitstream to generate a first decoded video and a second decoded video. The display apparatus displays a video based on the first decoded video and the second decoded video. The video compression apparatus includes a first compressor, a controller and a second compressor. The first compressor compresses the first video using a first codec to generate the first bitstream. The controller controls, based on a first random access point included in the first bitstream, a second random access point included in the second bitstream. The second compressor compresses the second video using a second codec different from the first codec based on the first decoded video corresponding to the first video to generate the second bitstream. The second bitstream is formed from a plurality of picture groups. Each of the plurality of picture groups includes at least one picture subgroup. The controller selects, from the second bitstream, an earliest picture subgroup on or after the first random access point in display order and sets an earliest picture of the selected picture subgroup in coding order as the second random access point.

Note that the same or similar reference numerals denote elements that are the same as or similar to those already explained, and a repetitive description will basically be omitted. A term “video” can be replaced with a term “image”, “pixel”, “image signal”, “picture”, “moving picture”, or “image data” as needed. A term “compression” can be replaced with a term “encoding” as needed. A term “codec” can be replaced with a term “moving picture compression standard.”

### First Embodiment

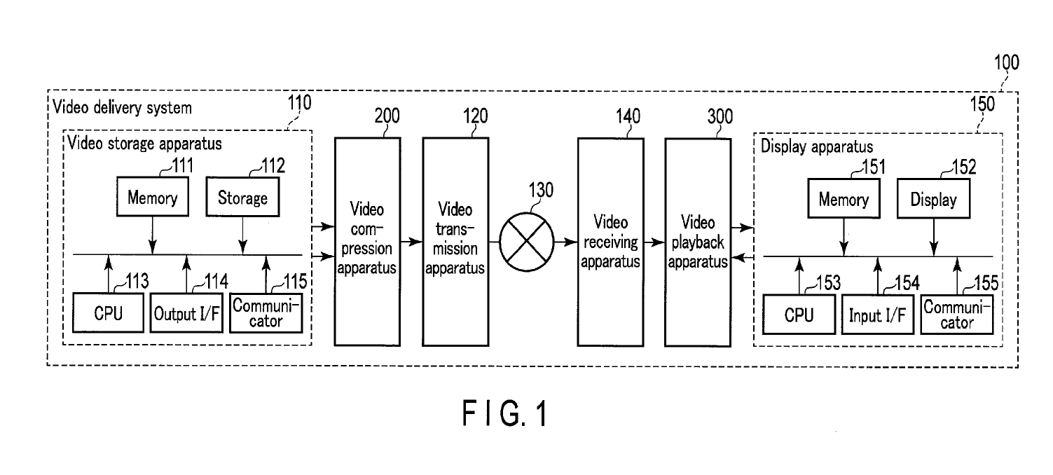

As shown in FIG. 1, a video delivery system 100 according to the first embodiment includes a video storage apparatus 110, a video compression apparatus 200, a video transmission apparatus 120, a channel 130, a video receiving apparatus 140, a video playback apparatus 300, and a display apparatus 150. Note that the video delivery system includes a system for broadcasting a video and a system for storing/reproducing a video in/from a storage medium (for example, magnetooptical disk or magnetic tape).

The video storage apparatus 110 includes a memory 111, a storage 112, a CPU (Central Processing Unit) 113, an output interface (I/F) 114, and a communicator 115. The video storage apparatus 110 stores and (real time) plays a baseband video shot by a camera or the like. For example, the video storage apparatus 110 can reproduce a video stored in a magnetic tape for a VTR (Video Tape Recorder), a video stored in the storage 112, or a video that the communicator 115 has received via a network (not shown). The video storage apparatus 110 may be used to edit a video.

The baseband video can be, for example, a raw video (for example, RAW format or Bayer format) shot by a camera and converted so as to be displayable on a monitor, or a video created using computer graphics (CG) and converted into a displayable format by rendering processing. The baseband video corresponds to a video before delivery. The baseband video may undergo various kinds of processing such as grading processing, video editing, scene selection, and subtitle insertion before delivery. The baseband video may be compressed before delivery. For example, a baseband video of full high vision (HDTV) (1920×1080 pixels, 60 fps, YUV 4:4:4 format) has a data rate as high as about 3 Gbit/sec, and therefore, compression may be applied to such an extent not to degrade the quality of the video.

The memory 111 temporarily saves programs to be executed by the CPU 113, data exchanged by the communicator 115, and the like. The storage 112 is a device capable of storing data (typically, video data); for example, a hard disk drive (HDD) or solid state drive.

The CPU 113 executes programs, thereby operating various kinds of functional units. More specifically, the CPU 113 up-converts or down-converts a baseband video saved in the storage 112, or converts the format of the baseband video.

The output I/F 114 outputs the baseband video to an external apparatus, for example, the video compression apparatus 200. The communicator 115 exchanges data with an external apparatus. Note that the elements of the video storage apparatus 110 shown in FIG. 1 can be omitted as needed, or an element (not shown) may be added as needed. For example, if the communicator 115 transmits the baseband video to the video compression apparatus 200, the output I/F 114 may be omitted. For example, a video shot by a camera (not shown) may directly be input to the video storage apparatus 110. In this case, an input I/F is added.

The video compression apparatus 200 receives the baseband video from the video storage apparatus 110, and (scalably-)compresses the baseband video using a scalable compression function, thereby generating a multiplexed bitstream in which a plurality of layers of compressed video data are multiplexed. The video compression apparatus 200 outputs the multiplexed bitstream to the video transmission apparatus 120.

Note that the scalable compression can suppress the total code amount when a plurality of bitstreams are generated, as compared to simultaneous compression, because the redundancy of enhancement layers with respect to a base layer is low. For example, if three bitstreams, 1 Mbps, 5 Mbps, and 10 Mbps are generated by simultaneous compression, the total code amount of the three bitstreams is 16 Mbps. On the other hand, according to scalable compression, information included in an enhancement layer is limited to information used to enhance the quality of the base layer video (which is omitted in the enhancement layer). Hence, when a bit rate of 1 Mbps is assigned to the base layer video, a bit rate of 4 Mbps is assigned to the first enhancement layer video, and a bit rate of 5 Mbps is assigned to the second enhancement layer video, a video having the same quality as that in the example of simultaneous compression can be provided using a total code amount of 10 Mbps.

In the following explanation, compressed video data will be handled in the bitstream format, and a term “bitstream” basically indicates compressed video data. Note that compressed audio data, information about a video, information about a playback timing, information about a channel, information about a multiplexing scheme, and the like can be handled in the bitstream format.

A bitstream can be stored in a multimedia container. The multimedia container is a format for storage and transmission of compressed data (that is, bitstream) of a video or audio. The multimedia container can be defined by, for example, MPEG-2 System, MP4 (MPEG-4 Part 14), MPEG-DASH (Dynamic Adaptive Streaming over HTTP), MMT (MPEG Multimedia Transport), or ASF (Advanced Systems Format). Compressed data includes a plurality of bitstreams or segments. One file can be created based on one segment or a plurality of segments.

The video transmission apparatus 120 receives a multiplexed bitstream for the video compression apparatus 200, and transmits the multiplexed bitstream to the video receiving apparatus 140 via the channel 130. For example, if the channel 130 corresponds to a transmission band of terrestrial digital broadcasting, the video transmission apparatus 120 can be an RF (Radio Frequency) transmission apparatus. If the channel 130 corresponds to a network line, the video transmission apparatus 120 can be an IP (Internet Protocol) communication apparatus.

The channel 130 is a communication means that connects the video transmission apparatus 120 and the video receiving apparatus 140. The channel 130 can be a wired channel, a wireless channel, or a mixture thereof. The channel 130 may be, for example, the Internet, a terrestrial broadcasting network, a satellite broadcasting network, or a cable transmission network. The channel 130 may be a channel for various kinds of communications, for example, radio wave communication, PHS (Personal Handy-phone System), 3G (3^{rd} Generation mobile standards), 4G (4^{th} Generation mobile standards), LTE (Long Term Evolution), millimeter wave communication, and radar communication.

The video receiving apparatus 140 receives the multiplexed bitstream from the video transmission apparatus 120 via the channel 130. The video reception apparatus 140 outputs the received multiplexed bitstream to the video playback apparatus 300. For example, if the channel 130 corresponds to a transmission band of terrestrial digital broadcasting, the video reception apparatus 140 can be an RF receiving apparatus (including an antenna to receive terrestrial digital broadcasting). If the channel 130 corresponds to a network line, the video receiving apparatus 140 can be an IP communication apparatus (including a function corresponding to a router or the like used to connect an IP network).

The video playback apparatus 300 receives the multiplexed bitstream from the video receiving apparatus 140, and (scalably-)decodes the multiplexed bitstream using the scalable compression function, thereby generating a decoded video. The video playback apparatus 300 outputs the decoded video to the display apparatus 150. The video playback apparatus 300 can be incorporated in a TV set main body or implemented as an STB (Set Top Box) separate from the TV set.

The display apparatus 150 receives the decoded video from the video playback apparatus 300 and displays the decoded video. The display apparatus 150 typically corresponds to a display (including a display for a PC), a TV set, or a video monitor. Note that the display apparatus 150 may be a touch screen or the like having an input I/F function in addition to the video display function.

As shown in FIG. 1, the display apparatus 150 includes a memory 151, a display 152, a CPU 153, an input I/F 154, and a communicator 155.

The memory 151 temporarily saves programs to be executed by the CPU 153, data exchanged by the communicator 155, and the like. The display 152 displays a video.

The CPU 153 executes programs, thereby operating various kinds of functional units. More specifically, the CPU 153 up-converts or down-converts a decoded video received from the display apparatus 150.

The input I/F 154 is an interface used by the user to input a user request. If the display apparatus 150 is a TV set, the input I/F 154 is typically a remote controller. The user can switch the channel or change the video display mode by operating the input I/F 154. Note that the input I/F 154 is not limited to a remote controller and may be, for example, a mouse, a touch pad, a touch screen, or a stylus. The communicator 155 exchanges data with an external apparatus.

Note that the elements of the display apparatus 150 shown in FIG. 1 can be omitted as needed, or an element (not shown) may be added as needed. For example, if a decoded video needs to be stored/accumulated in the display apparatus 150, a storage such as an HDD or SSD may be added.

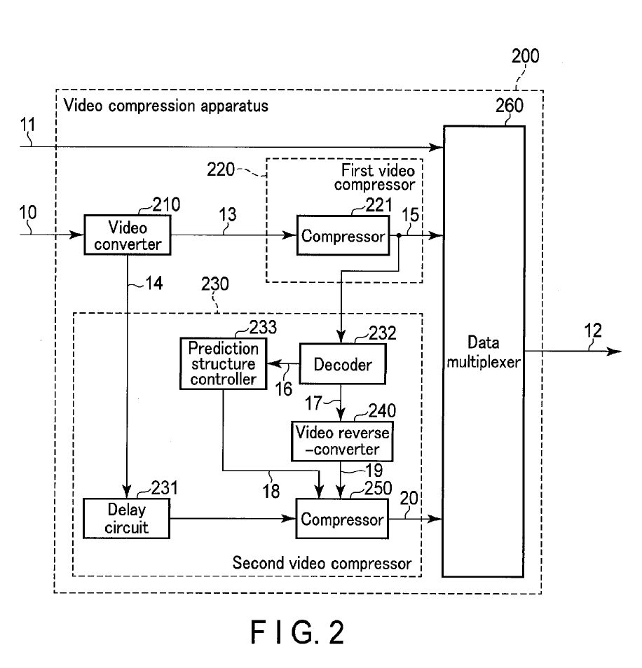

As shown in FIG. 2, the video compression apparatus 200 includes a video converter 210, a first video compressor 220, a second video compressor 230, and a data multiplexer 260. The video compression apparatus 200 receives a baseband video 10 and a video synchronizing signal 11 from the video storage apparatus 110, and compresses the baseband video 10 using the scalable compression function, thereby generating a plurality of layers (in the example of FIG. 2, two layers) of bitstreams. The video compression apparatus 200 multiplexes various kinds of control information generated based on the video synchronizing signal 11 and the plurality of layers of bitstreams to generate a multiplexed bitstream 12, and outputs the multiplexed bitstream 12 to the video transmission apparatus 120.

The video converter 210 receives the baseband video 10 from the video storage apparatus 110 and applies video conversion to the baseband video 10, thereby generating a first video 13 and a second video 14 (that is, the baseband video 10 is layered into the first video 13 and the second video 14). Here, layering means processing of preparing a plurality of videos to implement scalability. The first video 13 corresponds to a base layer video, and the second video 14 corresponds to an enhancement layer video. The video converter 210 outputs the first video 13 to the first video compressor 220, and outputs the second video 14 to the second video compressor 230.

The video conversion applied by the video converter 210 may correspond to at least one of (1) pass-through (no conversion), (2) upscaling or downscaling of the resolution, (3) p (Progressive)/i (Interlace) conversion to generate an interlaced video from a progressive video or i/p conversion corresponding to reverse-conversion, (4) increasing or decreasing of the frame rate, (5) increasing or decreasing of the bit depth (can also be referred to as an pixel bit length), (6) change of the color space format, and (7) increasing or decreasing of the dynamic range.

The video conversion applied by the video converter 210 may be selected in accordance with the type of scalability implemented by layering. For example, when implementing image quality scalability such as PSNR (Peak Signal-to-Noise Ratio) scalability or bit rate scalability, the first video 13 and the second video 14 may have the same video format, and the video converter 210 may select pass-through.

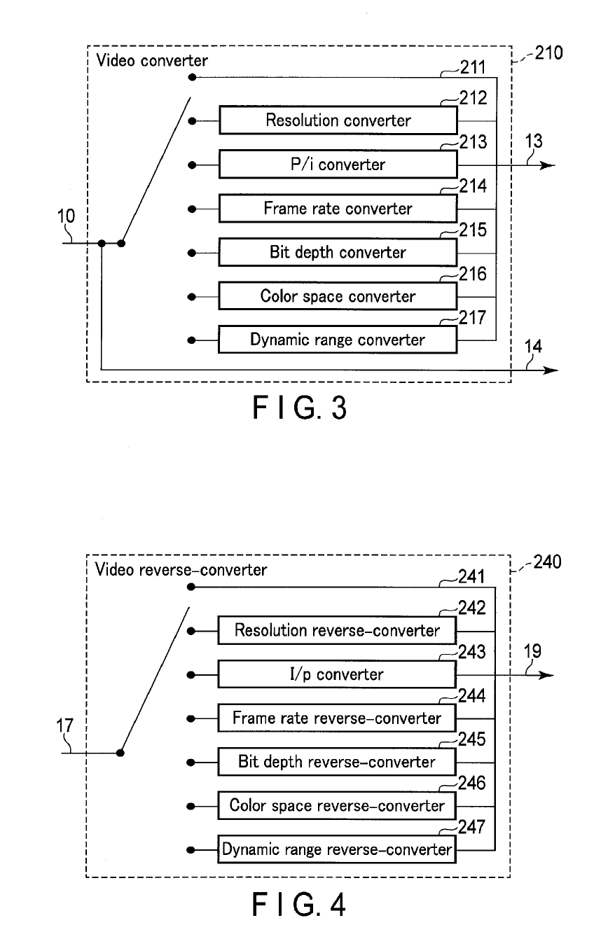

More specifically, as shown in FIG. 3, the video converter 210 includes a switch, a pass-through 211, a resolution converter 212, a p/i converter 213, a frame rate converter 214, a bit depth converter 215, a color space converter 216, and a dynamic range converter 217. The video converter 210 controls the output terminal of the switch based on the type of scalability implemented by layering, and guides the baseband video 10 to one of the pass-through 211, the resolution converter 212, the p/i converter 213, the frame rate converter 214, the bit depth converter 215, the color space converter 216, and the dynamic range converter 217. On the other hand, the video converter 210 directly outputs the baseband video 10 as the second video 14.

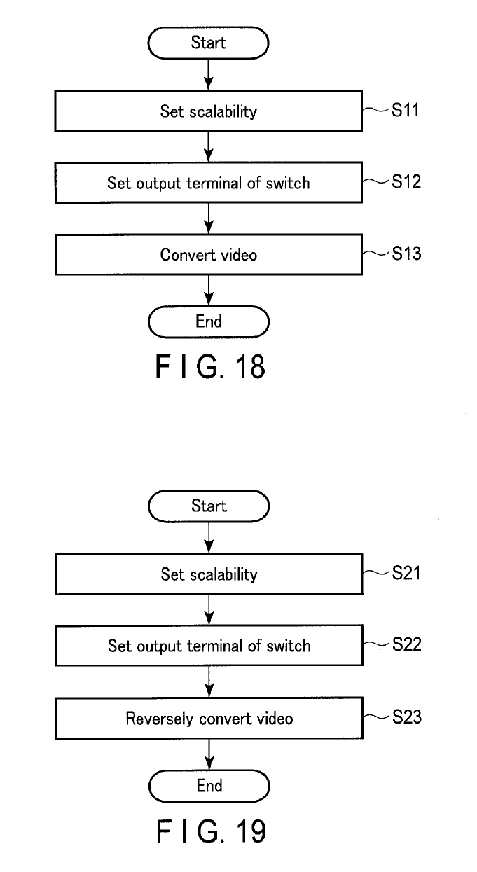

The video converter 210 shown in FIG. 3 operates as shown in FIG. 18. When the video converter 210 receives the baseband video 10, video conversion processing shown in FIG. 18 starts. The video converter 210 sets scalability to be implemented by layering (step S11). The video converter 210 sets, for example, image quality scalability, resolution scalability, temporal scalability, video format scalability, bit depth scalability, color space scalability, or dynamic range scalability.

The video converter 210 sets the connection destination of the output terminal of the switch based on the type of scalability set in step S11 (step S12). To where the output terminal of the switch is connected when what type of scalability is set will be described later.

The video converter 210 guides the baseband video 10 to the connection destination set in step S12, and applies video conversion, thereby generating the first video 13 (step S13). After step S13, the video conversion processing shown in FIG. 18 ends. Note that since the baseband video 10 is a moving picture, the video conversion processing shown in FIG. 18 is performed for each picture included in the baseband video 10.

To implement image quality scalability, the video converter 210 can connect the output terminal of the switch to the pass-through 211. The pass-through 211 directly outputs the baseband video 10 as the first video 13.

To implement resolution scalability, the video converter 210 can connect the output terminal of the switch to the resolution converter 212. The resolution converter 212 generates the first video 13 by changing the resolution of the baseband video 10. For example, the resolution converter 212 can down-convert the resolution of the baseband video 10 from 1920×1080 pixels to 1440×1080 pixels or convert the aspect ratio of the baseband video 10 from 16:9 to 4:3. Down-conversion can be implemented using, for example, linear filter processing.

To implement temporal scalability or video format scalability, the video converter 210 can connect the output terminal of the switch to the p/i converter 213. The p/i converter 213 generates the first video 13 by changing the video format of the baseband video 10 from the progressive video to interlaced video. P/i conversion can be implemented using, for example, linear filter processing. More specifically, the p/i converter 213 can perform down-conversion using an even-numbered frame of the baseband video 10 as a top field and an odd-numbered frame of the baseband video 10 as a bottom field.

To implement temporal scalability, the video converter 210 can connect the output terminal of the switch to the frame rate converter 214. The frame rate converter 214 generates the first video 13 by changing the frame rate of the baseband video 10. For example, the frame rate converter 214 can decrease the frame rate of the baseband video 10 from 60 fps to 30 fps.

To implement bit depth scalability, the video converter 210 can connect the output terminal of the switch to the bit depth converter 215. The bit depth converter 215 generates the first video 13 by changing the bit depth of the baseband video 10. For example, the bit depth converter 215 can reduce the bit depth of the baseband video 10 from 10 bits to 8 bits. More specifically, the bit depth converter 215 can perform bit shift in consideration of round-down or round-up, or perform mapping of pixel values using a look up table (LUT).

To implement color space scalability, the video converter 210 can connect the output terminal of the switch to the color space converter 216. The color space converter 216 generates the first video 13 by changing the color space format of the baseband video 10. For example, the color space converter 216 can change the color space format of the baseband video 10 from a color space format recommended by ITU-R Rec.BT.2020 to a color space format recommended by ITU-R Rec.BT.709 or a color space format recommended by ITU-R Rec.BT.609. Note that a transformation used to implement the change of the color space format exemplified here is described in the above recommendation. Change of another color space format can also easily be implemented using a predetermined transformation or the like.

To implement dynamic range scalability, the video converter 210 can connect the output terminal of the switch to the dynamic range converter 217. Note that the dynamic range scalability is sometimes used in a similar sense to the above-described bit depth scalability but here means changing the dynamic range with the bit depth kept fixed. The dynamic range converter 217 generates the first video 13 by changing the dynamic range of the baseband video 10. For example, the dynamic range converter 217 can narrow the dynamic range of the baseband video 10. More specifically, the dynamic range converter 217 can implement the change of the dynamic range by applying, to the baseband video 10, gamma conversion according to a dynamic range that a TV panel can express.

Note that the video converter 210 is not limited to the arrangement shown in FIG. 3. Hence, at least one of various functional units shown in FIG. 3 may be omitted as needed. In the example of FIG. 3, one of a plurality of video conversion processes is selected. However, a plurality of video conversion processes may be applied together. For example, to implement both resolution scalability and video format scalability, the video converter 210 may sequentially apply resolution conversion and p/i conversion to the baseband video 10.

When a combination of a plurality of target scalabilities are determined in advance, the calculation cost can be suppressed by sharing, in advance, a plurality of video conversion processes used to implement the plurality of scalabilities. For example, down-conversion and p/i conversion can be implemented using linear filter processing. Hence, if these processes are executed at once, arithmetic errors and rounding errors can be reduced as compared to a case where two linear filter processes are executed sequentially.

Alternatively, to compress a plurality of enhancement layer videos, one video conversion process may be divided into a plurality of stages. For example, the video converter 210 may generate the second video 14 by down-converting the resolution of the baseband video 10 from 3840×2160 pixels to 1920×1080 pixels and generate the first video 13 by down-converting the resolution of the second video 14 from 1920×1080 pixels to 1440×1080 pixels. In this case, the baseband video 10 having 3840×2160 pixels can be used as a third video (not shown) corresponding to an enhancement layer video of resolution higher than that of the second video 14.

The first video compressor 220 receives the first video 13 from the video converter 210 and compresses the first video 13, thereby generating the first bitstream 15. The codec used by the first video compressor 220 can be, for example, MPEG-2. The first video compressor 220 outputs the first bitstream 15 to the data multiplexer 260 and the second video compressor 230. Note that if the first video compressor 220 can generate a local decoded image of the first video 13, the local decoded image may be output to the second video compressor 230 together with the first bitstream 15. In this case, a decoder 232 to be described later may be replaced with a parser to analyze the prediction structure of the first bitstream 15. The first video compressor 220 includes a compressor 221. The compressor 221 partially or wholly performs the above-described operation of the first video compressor 220.

The second video compressor 230 receives the second video 14 from the video converter 210, and receives the first bitstream 15 from the first video compressor 220. The second video compressor 230 compresses the second video 14, thereby generating a second bitstream 20. The second video compressor 230 outputs the second bitstream 20 to the data multiplexer 260. As will be described later, the second video compressor 230 analyzes the prediction structure of the first bitstream 15, and controls the prediction structure of the second bitstream 20 based on the analyzed prediction structure, thereby improving the random accessibility of the second bitstream 20.

The second video compressor 230 includes a delay circuit 231, the decoder 232, a video reverse-converter 240, and a compressor 250.

The delay circuit 231 receives the second video 14 from the video converter 210, temporarily holds it, and then transfers it to the compressor 250. The delay circuit 231 controls the output timing of the second video 14 such that the second video 14 is input to the compressor 250 in synchronism with a reverse-converted video 19. In other words, the delay circuit 231 functions as a buffer that absorbs a processing delay by the first video compressor 220, the decoder 232, and the video reverse-converter 240. Note that the buffer corresponding to the delay circuit 231 may be incorporated in, for example, the video converter 210 in place of the second video compressor 230.

The decoder 232 receives the first bitstream 15 corresponding to the compressed data of the first video 13 from the first video compressor 220. The decoder 232 decodes the first bitstream 15, thereby generating a first decoded video 17. The decoder 232 uses the same codec (for example, MPEG-2) as that of the first video compressor 220 (compressor 221). The decoder 232 outputs the first decoded video 17 to the video reverse-converter 240.

The decoder 232 also analyzes the prediction structure of the first bitstream 15, and generates first prediction structure information 16 based on the analysis result. The first prediction structure information 16 indicates the number of random access points included in the first bitstream 15. Note that if the codec of the first bitstream 15 is MPEG-2, the decoder 232 can specify a picture of prediction type=I as a random access point. The decoder 232 outputs the first prediction structure information 16 to a prediction structure controller 233.

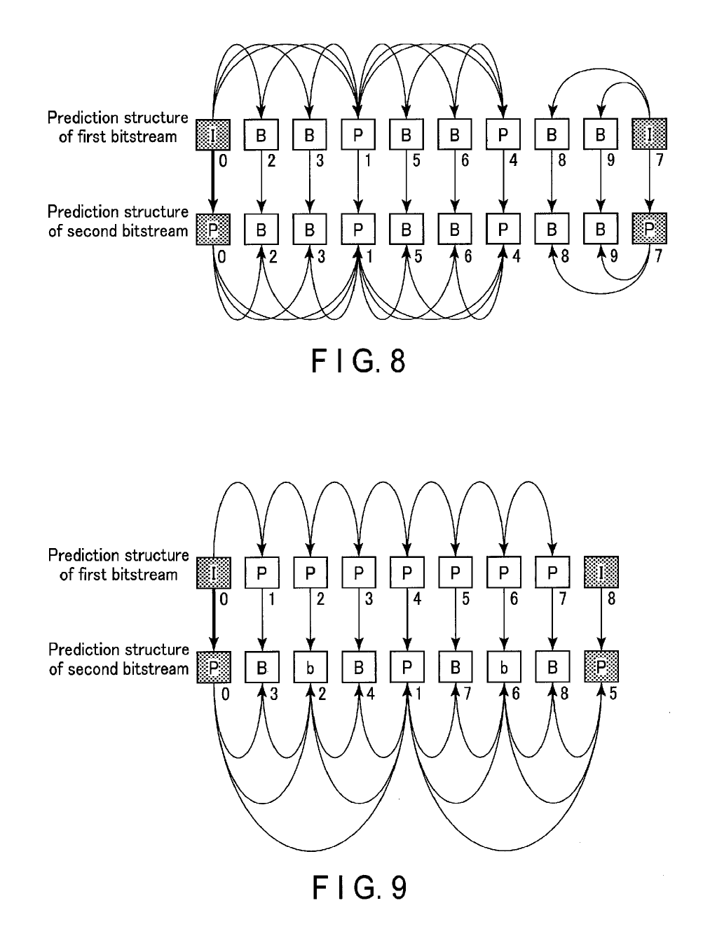

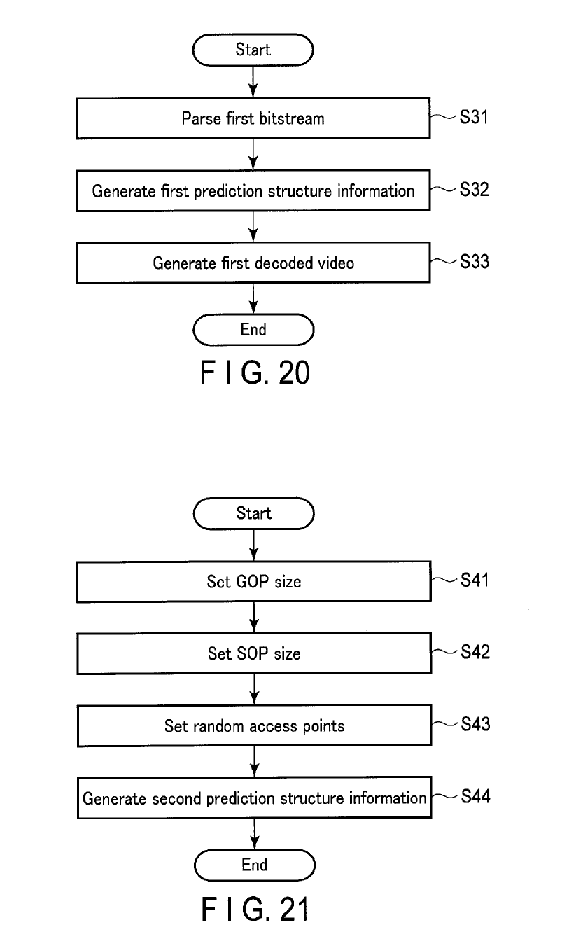

The decoder 232 operates as shown in FIG. 20. Note that if the codec used by the decoder 232 is MPEG-2, the decoder 232 can perform an operation that is the same as or similar to the operation of an existing MPEG-2 decoder. As will be described later with reference to FIG. 8, if the first bitstream 15 and the second bitstream 20 have the same prediction structure, and picture reordering is needed, the decoder 232 preferably directly outputs decoded pictures as the first decoded video 17 in the decoding order without rearranging them based on the display order.

When the decoder 232 receives the first bitstream 15, video decoding processing and syntax parse processing (analysis processing) shown in FIG. 20 start. The decoder 232 performs syntax parse processing for the first bitstream 15 and generates information necessary for video decoding processing in step S32 (step S31).

The decoder 232 extracts information about the prediction type of each picture from the information generated in step S31, and generates the first prediction structure information 16 (step S32). The decoder 232 decodes the first bitstream 15 using the information generated in step S31, thereby generating the first decoded video 17 (step S33). After step S33, the video decoding processing and the syntax parse processing shown in FIG. 20 end. Note that since the first bitstream 15 is the compressed data of a moving picture, the video decoding processing and the syntax parse processing shown in FIG. 20 are performed for each picture included in the first bitstream 15.

Note that if the first video compressor 220 can output a local decoded video (corresponding to the first decoded video 17) and the first prediction structure information 16, the decoder 232 can be omitted. If the first video compressor 220 can output not the first prediction structure information 16 but the local decoded video, the decoder 232 can be replaced with a parser (not shown). The parser performs syntax parse processing for the first bitstream 15, and generates the first prediction structure information 16 based on the result of the video decoding processing. The parser can be expected to attain a cost reduction effect because the scale of hardware and software necessary for implementation is smaller as compared to the decoder 232 that performs complex video decoding processing. The parser can also be added even in a case where the decoder 232 does not have the function of analyzing the prediction structure of the first bitstream 15 (for example, a case where the decoder 232 is implemented using a generic decoder).

As described above, when the arrangement of the second video compressor 230 is modified (for example, by addition of hardware or add-on of necessary functions) as needed in accordance with the arrangement of the first video compressor 220 or the decoder 232, the video compression apparatus shown in FIG. 2 can be implemented using an encoder or decoder already commercially available or in service.

The prediction structure controller 233 receives the first prediction structure information 16 from the decoder 232. Based on the first prediction structure information 16, the prediction structure controller 233 generates second prediction structure information 18 used to control the prediction structure of the second bitstream 20. The prediction structure controller 233 outputs the second prediction structure information 18 to the compressor 250.

Compressed video data (bitstream) is formed by a plurality of picture groups (to be referred to as a GOP (Group Of Pictures)). The GOP includes a picture sequence from a picture corresponding to a certain random access point to a picture corresponding to the next random access point. The GOP also includes at least one picture subgroup corresponding to a picture sequence having one of predetermined reference relationships. That is, a reference relationship that a GOP has can be represented by a combination of the basic reference relationships. The subgroup is called a SOP (Sub-group Of Pictures or Structure Of Pictures). A SOP size (also expressed as M) equals a total number of pictures included in the SOP. A GOP size (to be described later) equals a total number of pictures included in the GOP.

More specifically, in MPEG-2, three prediction types called I (Intra) picture, P (Predictive) picture, and B (Bi-predictive) picture are usable. Note that in MPEG-2, a B picture is handled as a non-reference picture. From the viewpoint of compression efficiency and compression delay, a prediction structure (M=1) in which both the coding order and the display order are IPPP and a prediction structure (M=3) in which the coding order is IPBB, and the display order is IBBP are typically used.

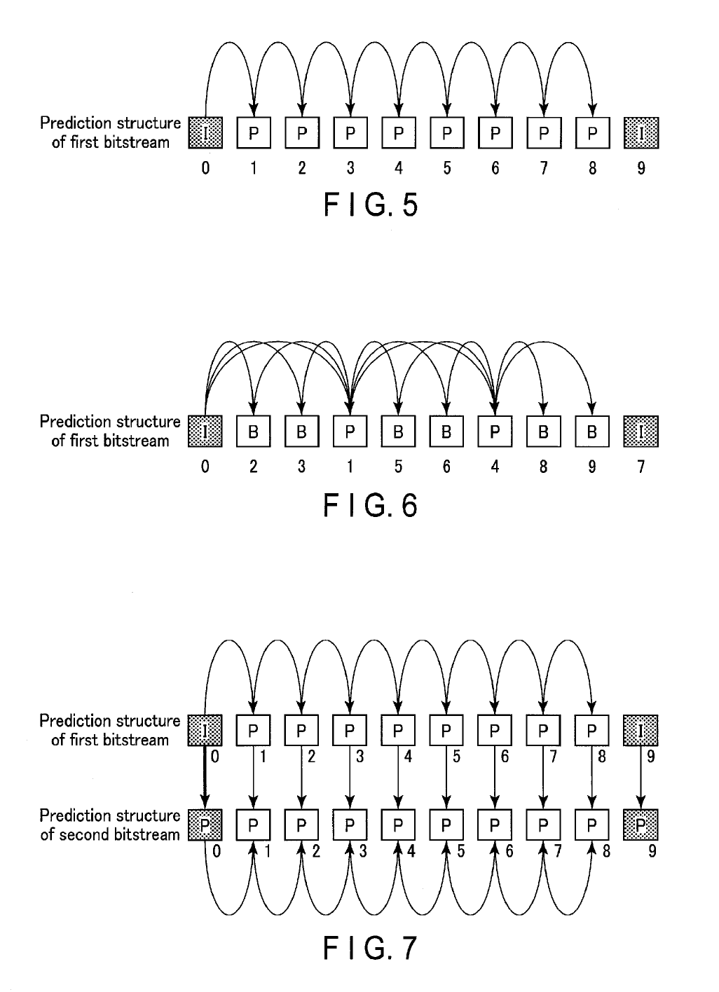

If the codec used by the first video compressor 220 is MPEG-2, the first bitstream 15 typically has a prediction structure shown in FIG. 5 or 6. FIG. 5 shows a prediction structure in which SOP size=1, and GOP size=9. FIG. 6 shows a prediction structure in which SOP size=3, and GOP size=9.

In FIG. 5 and subsequent drawings, each box represents one picture, and the pictures are arranged in accordance with the display order. A letter in each box represents the prediction type of the picture corresponding to the box, and a number under each box represents the coding order (decoding order) of the picture corresponding to the box. In the prediction structure shown in FIG. 5, since the display order of the pictures is the same as the coding order, picture reordering is unnecessary. Additionally, in the prediction structures shown in FIGS. 5 and 6, since GOP size=9, the I picture of the latest display order (that is, illustrated at the right end) belongs to a GOP different from that of the remaining pictures. As described above, in MPEG-2, a B picture is handled as a non-reference picture. For this reason, a prediction structure having a smaller SOP size is likely to be selected as compared to H.264 and HEVC.

Note that the prediction structures shown in FIG. 5 and subsequent drawings are merely examples, and the first bitstream 15 and the second bitstream 20 may have various SOP sizes, GOP sizes, and reference relationships within the allocable range of the codec. The prediction structures of the first bitstream 15 and the second bitstream 20 need not be fixed, and may dynamically be changed depending on various factors, for example, video characteristics, user control, and the bandwidth of a channel. For example, inserting an I picture immediately after scene change and switching the GOP size and the SOP size are performed even in an existing general video compression apparatus. The SOP size of a video may be switched in accordance with the level of temporal correlation of the video.

On the other hand, in H.264 and HEVC, the prediction type is set on a slice basis, and an I slice, P slice, and B slice are usable. In the following explanation, a picture including a B slice will be referred to as a B picture, a picture including not a B slice but an I slice will be referred to as a P picture, and a picture including neither a B slice nor a P slice but an I slice will be referred to as an I picture for descriptive convenience. In H.264 and HEVC, since a B picture can also be designated as a reference picture, the compression efficiency can be raised. In H.264 and HEVC, a prediction structure with M=4 in which the coding order is IPbBB, and the display order is IBbBP, and a prediction structure with M=8 are typically used. Note that here, a non-reference B picture is expressed as B, and a reference B picture is expressed as b. These prediction structures are also called hierarchical B structures. M of a hierarchical B structure can be represented by a power of 2.

If the prediction structure of the second bitstream 20 is made to match the prediction structure shown in FIG. 5, the prediction structure of the first bitstream 15 and that of the second bitstream 20 have a relationship shown in FIG. 7. Similarly, if the prediction structure of the second bitstream 20 is made to match the prediction structure shown in FIG. 6, the prediction structure of the first bitstream 15 and that of the second bitstream 20 have a relationship shown in FIG. 8.

According to inter-layer prediction (to be described later), each picture included in the second bitstream 20 can refer to the decoded picture of a picture of the same time included in the first bitstream 15. Additionally, in the examples of FIGS. 7 and 8, since the GOP size of the second bitstream 20 matches the GOP size of the first bitstream 15, the second bitstream 20 can be decoded and reproduced from decoded pictures corresponding to the random access points (I pictures) included in the first bitstream 15.

In the example of FIG. 7, the prediction structures of the first bitstream 15 and the second bitstream 20 do not need reordering. Hence, when decoding of a picture of an arbitrary time in the first bitstream 15 is completed, the second video compressor 230 can immediately compress a picture of the same time in the second bitstream 20. That is, the compression delay is very small.

In the example of FIG. 8, the prediction structures of the first bitstream 15 and the second bitstream 20 need reordering. As described above, each picture included in the second bitstream 20 can refer to the decoded picture of a picture included of the same time in the first bitstream 15. However, if the decoder 232 is implemented using a generic decoder that performs picture reordering and outputs a decoded video in accordance with the display order, a delay is generated from generation to output of the first decoded video 17.

More specifically, the P picture of decoding order=1 included in the first bitstream 15 shown in FIG. 8 is displayed later than the B picture of decoding order=2 or 3. Hence, output of the decoded picture of the P picture delays until decoding and output of these B pictures are completed. In the second bitstream 20, compression of a P picture of the same time as the P picture also delays. To suppress the compression delay, the decoder 232 preferably outputs the decoded pictures as the first decoded video 17 in the decoding order without rearranging them based on the display order. If the decoder 232 operates in this way, the second video compressor 230 can immediately compress a picture of an arbitrary time in the second bitstream 20 after decoding of a picture of the same time in the first bitstream 15 is completed, as in the example of FIG. 7.

As shown in FIGS. 7 and 8, matching of the prediction structure of the second bitstream 20 with the prediction structure of the first bitstream 15 is preferable from the viewpoint of random accessibility and compression delay. On the other hand, from the viewpoint of compression efficiency, it is not preferable that the prediction structure of the second bitstream 20 is limited by the prediction structure of the first bitstream 15, and an advanced prediction structure such as the above-described hierarchical B structure cannot be used.

If the prediction structure of the second bitstream 20 is determined independently of the prediction structure of the first bitstream 15, the prediction structures of these bitstreams do not necessarily match. For example, the prediction structure of the first bitstream 15 and that of the second bitstream 20 may have a relationship shown in FIG. 9, 10, or 11.

In the example of FIG. 9, the first bitstream 15 has a prediction structure in which SOP size=1, and GOP size=8, and the second bitstream 20 has a prediction structure in which SOP size=4, and GOP size=8. Since the prediction structure of the second bitstream 20 corresponds to the above-described hierarchical B structure, a high compression efficiency can be achieved. In the example of FIG. 9, however, the compression delay of the second bitstream 20 increases as compared to the examples shown in FIGS. 7 and 8. For example, a picture of decoding order=1 included in the second bitstream 20 refers to the decoded video of a picture of decoding order=4 included in the first bitstream 15 and therefore, cannot be compressed until decoding of pictures of decoding orders=1 to 4 included in the first bitstream 15 is completed.

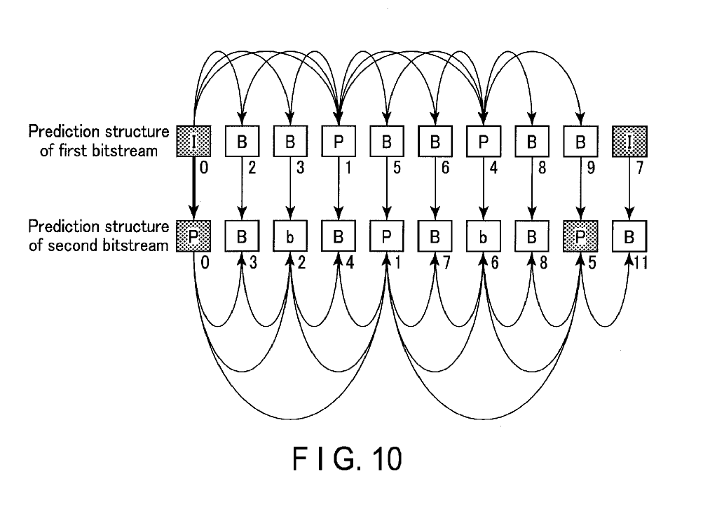

In the example of FIG. 10, the first bitstream 15 has a prediction structure in which SOP size=3, and GOP size=9, and the second bitstream 20 has a prediction structure in which SOP size=4, and GOP size=8. Since the prediction structure of the second bitstream 20 corresponds to the above-described hierarchical B structure, a high compression efficiency can be achieved. In the example of FIG. 10, however, the compression delay of the second bitstream 20 increases as compared to the examples shown in FIGS. 7 and 8, as in the example of FIG. 9. In addition, since the GOP size of the first bitstream 15 is different from that of the second bitstream 20, there may be a mismatch between random access points. For example, assume that playback starts from the I picture of coding order=7 included in the first bitstream 15. The picture that can be decoded and reproduced correctly for the first time in the second bitstream 20 is a picture (typically, P picture) on or after the 9th picture in the display order corresponding to the random access point of the earliest coding order. As described above, if the GOP size of the first bitstream 15 and that of the second bitstream 20 are different, a playback delay corresponding to the GOP size of the second bitstream 20 is generated at maximum.

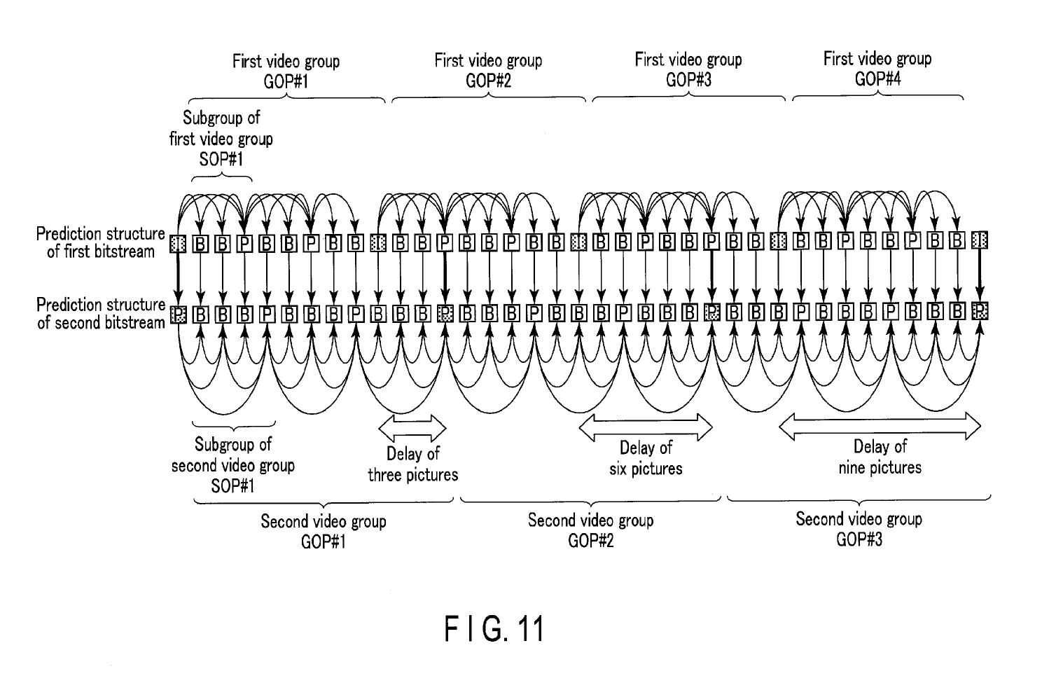

In an example of FIG. 11, the first bitstream 15 has a prediction structure in which SOP size=3, and GOP size=9, and the second bitstream 20 has a prediction structure in which SOP size=4, and GOP size=12. Referring to FIG. 11, the first bitstream 15 includes four GOPs (GOP#1, GOP#2, GOP#3, and GOP#4), and each GOP includes three SOPS (SOP#1, SOP#2, and SOP#3). On the other hand, the second bitstream 20 includes three GOPs (GOP#1, GOP#2, and GOP#3), and each GOP includes three SOPs (SOP#1, SOP#2, and SOP#3). In the example of FIG. 11 as well, the same problem as in FIG. 10 arises. For example, if playback starts from the first picture of GOP#2 of the first bitstream 15, the picture that can be decoded and reproduced correctly for the first time in the second bitstream 20 is the first picture of GOP#2. Similarly, assume that playback starts from the first picture of GOP#3 of the first bitstream 15. The picture that can be decoded and reproduced correctly for the first time in the second bitstream 20 is the first picture of GOP#3.

Generally speaking, if the prediction structure of the second bitstream 20 is made to match that of the first bitstream 15, the compression efficiency of the second bitstream 20 may lower. If the prediction structure of the second bitstream 20 is not changed at all, the random accessibility of the second bitstream 20 may degrade, and the compression delay may increase. Note that to ensure the compatibility with an existing video playback apparatus that uses the same codec as that of the first video compressor 220, the prediction structure of the first bitstream 15 may be unchangeable. Hence, the prediction structure controller 233 controls the random access points without changing the SOP size of the second bitstream 20, thereby improving the random accessibility while avoiding lowering the compression efficiency of the second bitstream 20 and increasing the compression delay and the device cost.

More specifically, the prediction structure controller 233 sets random access points in the second bitstream 20 based on the random access points included in the first bitstream 15. The random access points included in the first bitstream 15 can be specified based on the first prediction structure information 16.

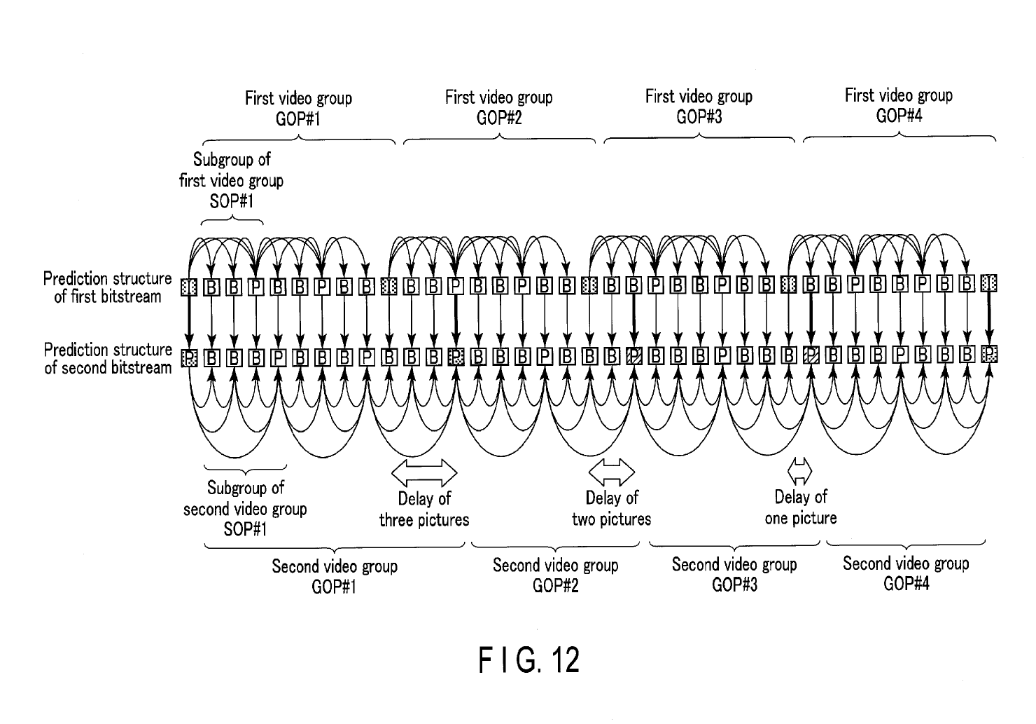

For example, upon detecting a random access point (for example, I picture) included in the first bitstream 15 based on the first prediction structure information 16, the prediction structure controller 233 selects, from the second bitstream 20, the earliest SOP on or after the detected random access point in display order. Then, the prediction structure controller 233 sets the earliest picture of the selected SOP in coding order as a random access point for the second bitstream 20. That is, if the first bitstream 15 and the second bitstream 20 have the prediction structures shown in FIG. 11 by default, the prediction structure controller 233 controls the prediction structure of the second bitstream 20 as shown in FIG. 12.

As can be seen from comparison of FIGS. 11 and 12, the total number of GOPs included in the second bitstream 20 increases from three to four. In the example shown in FIG. 12, if playback starts from the first picture of GOP#2 of the first bitstream 15, the picture that can be decoded and reproduced correctly for the first time in the second bitstream 20 is the first picture of GOP#2. The playback delay in this case is the same as in the example of FIG. 11. However, if playback starts from the first picture of GOP#3 of the first bitstream 15, the picture that can be decoded and reproduced correctly for the first time in the second bitstream 20 is the first picture of GOP#3. The playback delay in this case is improved by an amount corresponding to four pictures as compared to FIG. 11. Generally speaking, if the prediction structure controller 233 controls the random access points in the second bitstream 20 as described above, the upper limit of the playback delay is determined not by the GOP size but by the SOP size of the second bitstream 20. Hence, the random accessibility improves as compared to a case where the prediction structure of the second bitstream 20 is not changed at all.

The prediction structure controller 233 operates as shown in FIG. 21. When the prediction structure controller 233 receives the first prediction structure information 16, prediction structure control processing shown in FIG. 21 starts. The prediction structure controller 233 sets a (default) GOP size and SOP size to be used by the compressor 250 (steps S41 and S42).

The prediction structure controller 233 sets random access points in the second bitstream 20 based on the first prediction structure information 16 and the GOP size and SOP size set in steps S41 and S42 (step S43).

More specifically, the prediction structure controller 233 sets the first picture of each GOP as a random access point in accordance with the default GOP size set in step S41 unless a random access point in the first bitstream 15 is detected based on the first prediction structure information 16. On the other hand, if a random access point in the first bitstream 15 is detected based on the first prediction structure information 16, the prediction structure controller 233 selects, from the second bitstream 20, the earliest SOP on or after the detected random access point in display order. Then, the prediction structure controller 233 sets the earliest picture of the selected SOP in coding order as a random access point for the second bitstream 20. In this case, the GOP size of the GOP immediately before the random access point may be shortened as compared to the GOP size set in step S41.

The prediction structure controller 233 generates the second prediction structure information 18 representing the GOP size, SOP size, and random access points set in steps S41, S42, and S43, respectively (step S44). After step S44, the prediction structure control processing shown in FIG. 21 ends. Note that since the first prediction structure information 16 is information about the compressed data (first bitstream 15) of a moving picture, the prediction structure control processing shown in FIG. 21 is performed for each picture included in the first bitstream 15.

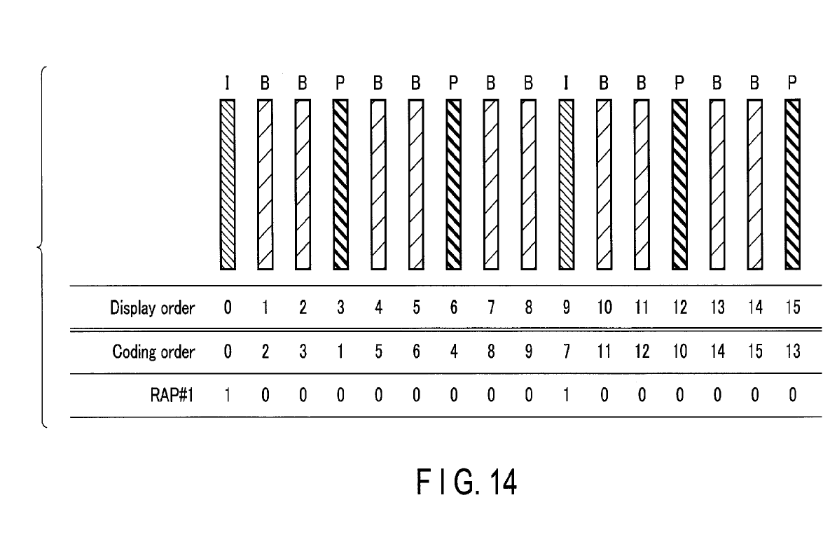

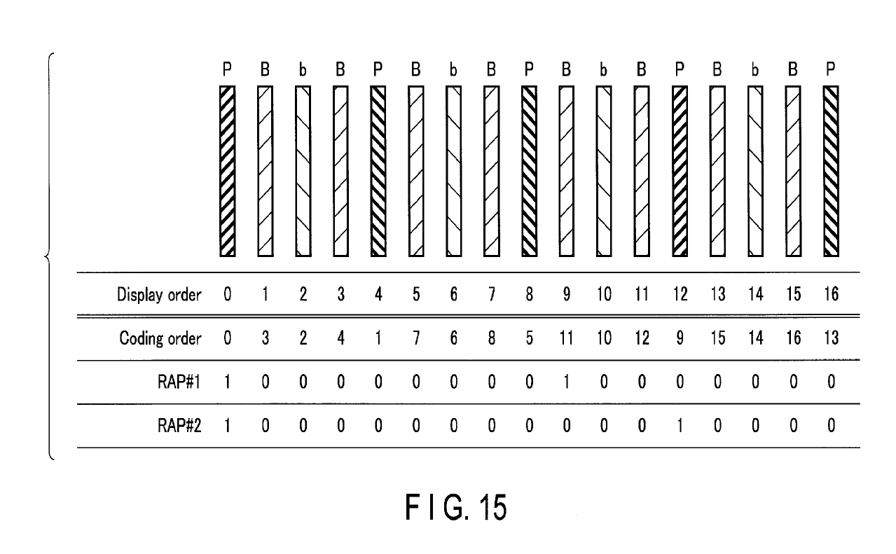

The prediction structure controller 233 may generate the second prediction structure information 18 shown in FIG. 15 based on the first prediction structure information 16 shown in FIG. 14.

The first prediction structure information 16 shown in FIG. 14 includes, for each picture included in the first bitstream 15, the display order and coding order of the picture and information (flag) RAP#1 representing whether the picture corresponds to a random access point (RAP). RAP#1 is set to “1” if the corresponding picture corresponds to a random access point, and “0” if the corresponding picture does not correspond to a random access point. In the example of FIG. 14, RAP#1 corresponding to a picture of prediction type=I is set to “1”, and RAP#1 corresponding to a picture of prediction type=P or B is set to “0”.

The second prediction structure information 18 shown in FIG. 15 includes, for each picture included in the second bitstream 20, the display order and compression order of the picture and information (flag) RAP#2 representing whether the picture corresponds to a random access point. RAP#2 is set to “1” if the corresponding picture corresponds to a random access point, and “0” if the corresponding picture does not correspond to a random access point.

By referring to RAP#1 shown in FIG. 14, the prediction structure controller 233 detects a picture with RAP#1 set to “1” as a random access point in the first bitstream 15. In the example of FIG. 14, pictures of display orders=0, 9 in the first bitstream 15 are detected. The prediction structure controller 233 then selects, from the second bitstream, the earliest SOP on or after the random access point in display order and sets an earliest picture of the selected SOP in coding order as a random access point for the second bitstream 20, and generates the second prediction structure information 18 (RAP#2) representing the positions of the set random access points.

As shown in FIG. 15, if the default prediction structure of the second bitstream 20 is a hierarchical B structure with M=4, pictures of display orders=0, 4, 8, 12, 16, . . . have the first positions in coding order of SOPs. That is, the prediction structure controller 233 sets the picture of display order=0 (≧0) in the second bitstream 20 as a random access point in accordance with detection of the picture of display order=0 in the first bitstream 15. In addition, the prediction structure controller 233 sets the picture of display order=12 (≧9) in the second bitstream 20 as a random access point in accordance with detection of the picture of display order=9 in the first bitstream 15.

Note that the compressor 250 to be described later can transmit a picture corresponding to a random access point in the second bitstream 20 to the video playback apparatus 300 by various means.

More specifically, according to the format (syntax information or the like) of HEVC and SHVC, the compressor 250 can describe, in the second bitstream 20, information explicitly representing that a picture set to a random access point is random-accessible. The compressor 250 may, for example, designate a picture corresponding to a random access point as a CRA (Clean Random Access) picture or IDR (Instantaneous Decoding Refresh) picture, or an IRAP (Intra Random Access Point) access unit or IRAP picture defined in HEVC. Note that “access unit” is a term that means one set of NAL (Network Abstraction Layer) units. The video playback apparatus 300 can know that these pictures (or access units) are random-accessible.

The compressor 250 can also describe the information explicitly representing that a picture set to a random access point is random-accessible in the second bitstream 20 not as indispensable information for decoding but supplemental information. For example, the compressor 250 can use a Recovery point SEI (Supplemental Enhancement Information) message defined in H.264, HEVC, and SHVC.

Alternatively, the compressor 250 may not describe the information explicitly representing that a picture set to a random access point is random-accessible in the second bitstream 20. More specifically, the compressor 250 may limit the prediction mode of a picture to immediately decode the picture. Limiting the prediction mode may exclude inter-frame prediction (for example, merge mode or motion compensation prediction to be described later) from various usable prediction modes. In this case, the compressor 250 uses a prediction mode (for example, intra prediction or inter-layer prediction to be described later) that is not based on a reference image at a temporal position different from that of a compression target picture.

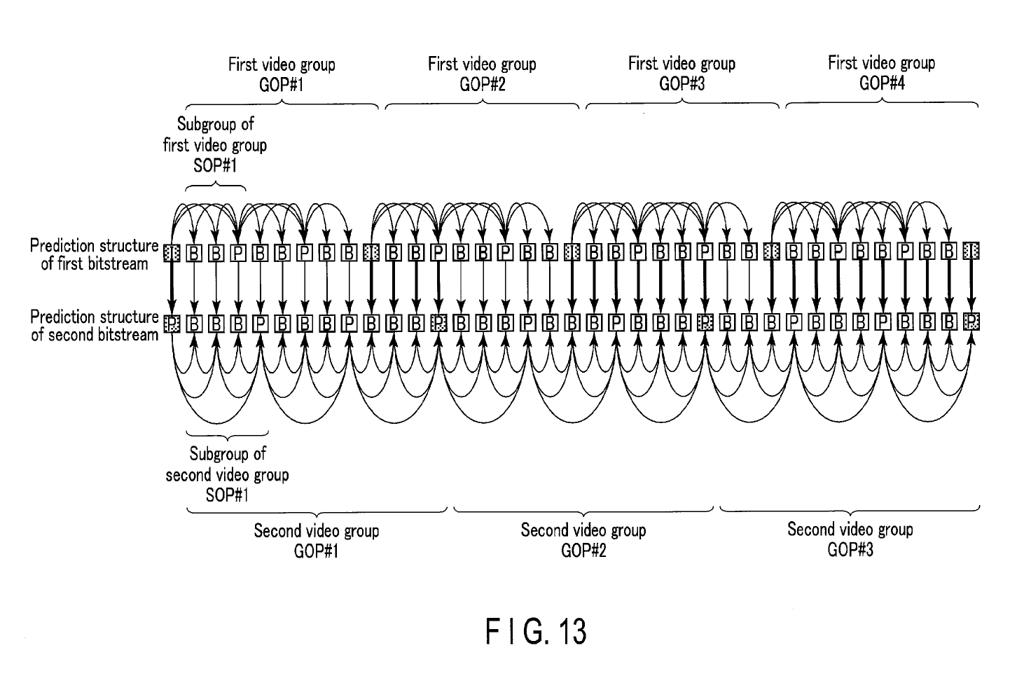

Although the compression efficiency of a picture of limited prediction mode may lower, the picture can be decoded immediately when the picture of the same time in the first bitstream 15 is decoded. As shown in FIG. 13, in the second bitstream 20, the compressor 250 limits the prediction modes of one or more pictures from the picture of the same time as each random access point in the first bitstream 15 up to the last picture of the GOP to which the picture belongs (these pictures are indicated by thick arrows in FIG. 13).

According to this example, since the video playback apparatus 300 can immediately decode a picture of the same time as a random access point in the first bitstream 15, the decoding delay of the second bitstream 20 is very small (that is, the random accessibility is high). Note that the decoding delay discussed here does not include delays in reception of a bitstream and execution of picture reordering. Note that the video playback apparatus 300 may be notified using, for example, the above-described SEI message that a given picture in the second bitstream 20 is random-accessible. Alternatively, it may be defined in advance that the video playback apparatus 300 determines based on the first bitstream 15 whether a given picture in the second bitstream 20 is random-accessible.

The video reverse-converter 240 receives the first decoded video 17 from the decoder 232. The video reverse-converter 240 applies video reverse-conversion to the first decoded video 17, thereby generating the reverse-converted video 19. The video reverse-converter 240 outputs the reverse-converted video 19 to the compressor 250. The video format of the reverse-converted video 19 matches that of the second video 14. That is, if the baseband video 10 and the second video 14 have the same video format, the video reverse-converter 240 performs conversion reverse to that of the video converter 210. Note that if the video format of the first decoded video 17 (that is, first video 13) is the same as the video format of the second video 14, the video reverse-converter 240 may select pass-through.

More specifically, as shown in FIG. 4, the video reverse-converter 240 includes a switch, a pass-through 241, a resolution reverse-converter 242, an i/p converter 243, a frame rate reverse-converter 244, a bit depth reverse-converter 245, a color space reverse-converter 246, and a dynamic range reverse-converter 247. The video reverse-converter 240 controls the output terminal of the switch based on the type of scalability implemented by layering (in other words, video conversion applied by the video converter 210), and guides the first decoded video 17 to one of the pass-through 241, the resolution reverse-converter 242, the i/p converter 243, the frame rate reverse-converter 244, the bit depth reverse-converter 245, the color space reverse-converter 246, and the dynamic range reverse-converter 247. The switch shown in FIG. 4 is controlled in synchronism with the switch shown in FIG. 3.

The video reverse-converter 240 shown in FIG. 4 operates as shown in FIG. 19. When the video reverse-converter 240 receives the first decoded video 17, video reverse-conversion processing shown in FIG. 19 starts. The video reverse-converter 240 sets scalability to be implemented by layering (step S21). The video reverse-converter 240 sets, for example, image quality scalability, resolution scalability, temporal scalability, video format scalability, bit depth scalability, color space scalability, or dynamic range scalability.

The video reverse-converter 240 sets the connection destination of the output terminal of the switch based on the type of scalability set in step S21 (step S22). To where the output terminal of the switch is connected when what type of scalability is set will be described later.

The video reverse-converter 240 guides the first decoded video 17 to the connection destination set in step S22, and applies video reverse-conversion, thereby generating the reverse-converted video 19 (step S23). After step S23, the video reverse-conversion processing shown in FIG. 19 ends. Note that since the first decoded video 17 is a moving picture, the video reverse-conversion processing shown in FIG. 19 is performed for each picture included in the first decoded video 17.

To implement image quality scalability, the video reverse-converter 240 can connect the output terminal of the switch to the pass-through 241. The pass-through 241 directly outputs the first decoded video 17 as the reverse-converted video 19.

To implement resolution scalability, the video reverse-converter 240 can connect the output terminal of the switch to the resolution reverse-converter 242. The resolution reverse-converter 242 generates the reverse-converted video 19 by changing the resolution of the first decoded video 17. For example, the video reverse-converter 240 can up-convert the resolution of the first decoded video 17 from 1440×1080 pixels to 1920×1080 pixels or convert the aspect ratio of the first decoded video 17 from 4:3 to 16:9. Up-conversion can be implemented using, for example, linear filter processing or super resolution processing.

To implement temporal scalability or video format scalability, the video reverse-converter 240 can connect the output terminal of the switch to the i/p converter 243. The i/p converter 243 generates the reverse-converted video 19 by changing the video format of the first decoded video 17 from the interlaced video to the progressive video. I/p conversion can be implemented using, for example, linear filter processing.

To implement temporal scalability, the video reverse-converter 240 can connect the output terminal of the switch to the frame rate reverse-converter 244. The frame rate reverse-converter 244 generates the reverse-converted video 19 by changing the frame rate of the first decoded video 17. For example, the frame rate reverse-converter 244 can perform interpolation processing for the first decoded video 17 to increase the frame rate from 30 fps to 60 fps. The interpolation processing can use, for example, a motion search for a plurality of frames before and after a frame to be generated.

To implement bit depth scalability, the video reverse-converter 240 can connect the output terminal of the switch to the bit depth reverse-converter 245. The bit depth reverse-converter 245 generates the reverse-converted video 19 by changing the bit depth of the first decoded video 17. For example, the bit depth reverse-converter 245 can extend the bit depth of the first decoded video 17 from 8 bits to 10 bits. Bit depth extension can be implemented using left bit shift or mapping of pixel values using an LUT.

To implement color space scalability, the video reverse-converter 240 can connect the output terminal of the switch to the color space reverse-converter 246. The color space reverse-converter 246 generates the reverse-converted video 19 by changing the color space format of the first decoded video 17. For example, the color space reverse-converter 246 can change the color space of the first decoded video 17 from a color space format recommended by ITU-R Rec.BT.709 to a color space format recommended by ITU-R Rec.BT.2020. Note that a transformation used to implement the change of the color space format exemplified here is described in the above recommendation. Change of another color space format can also easily be implemented using a predetermined transformation or the like.

To implement dynamic range scalability, the video reverse-converter 240 can connect the output terminal of the switch to the dynamic range reverse-converter 247. The dynamic range reverse-converter 247 generates the reverse-converted video 19 by changing the dynamic range of the first decoded video 17. For example, the dynamic range reverse-converter 247 can widen the dynamic range of the first decoded video 17. More specifically, the dynamic range reverse-converter 247 can implement the change of the dynamic range by applying, to the first decoded video 17, gamma conversion according to a dynamic range that a TV panel can express.

Note that the video reverse-converter 240 is not limited to the arrangement shown in FIG. 4. Hence, some or all of various functional units shown in FIG. 4 may be omitted as needed. In the example of FIG. 4, one of a plurality of video reverse-conversion processes is selected. However, a plurality of video reverse-conversion processes may be applied together. For example, to implement both resolution scalability and video format scalability, the video reverse-converter 240 may sequentially apply resolution conversion and i/p conversion to the first decoded video 17.

When a combination of a plurality of target scalabilities is determined in advance, the calculation cost can be suppressed by sharing, in advance, a plurality of video reverse-conversion processes used to implement the plurality of scalabilities. For example, up-conversion and i/p conversion can be implemented using linear filter processing. Hence, if these processes are executed at once, arithmetic errors and rounding errors can be reduced as compared to a case where two linear filter processes are executed sequentially.

Alternatively, to compress a plurality of enhancement layer videos, one video reverse-conversion process may be divided into a plurality of stages. For example, the video reverse-converter 240 may generate the reverse-converted video 19 by up-converting the resolution of the first decoded video 17 from 1440×1080 pixels to 1920×1080 pixels, and further up-convert the resolution of the reverse-converted video 19 from 1920×1080 pixels to 3840×2160 pixels. The video having 3840×2160 pixels can be used to compress the third video (not shown) corresponding to an enhancement layer video of resolution higher than that of the second video 14.

Note that information about the video format of the first video 13 is explicitly embedded in the first bitstream 15. Similarly, information about the video format of the second video 14 is explicitly embedded in the second bitstream 20. Note that the information about the video format of the first video 13 may explicitly be embedded in the second bitstream 20 in addition the first bitstream 15.

The information about the video format is, for example, information representing that a video is a progressive video or interlaced video, information representing the phase of an interlaced video, information representing the frame rate of a video, information representing the resolution of a video, information representing the bit depth of a video, information representing the color space format of a video, or information representing the codec of a video.

The compressor 250 receives the second video 14 from the delay circuit 231, receives the second prediction structure information 18 from the prediction structure controller 233, and receives the reverse-converted video 19 from the video reverse-converter 240. The compressor 250 compresses the second video 14 based on the reverse-converted video 19, thereby generating the second bitstream 20. Note that the compressor 250 compresses the second video 14 in accordance with the prediction structure (the GOP size, the SOP size, and the positions of random access points) represented by the second prediction structure information 18. The compressor 250 uses a codec (for example, SHVC) different from that of the first video compressor 220 (compressor 221). The compressor 250 outputs the second bitstream 20 to the data multiplexer 260.

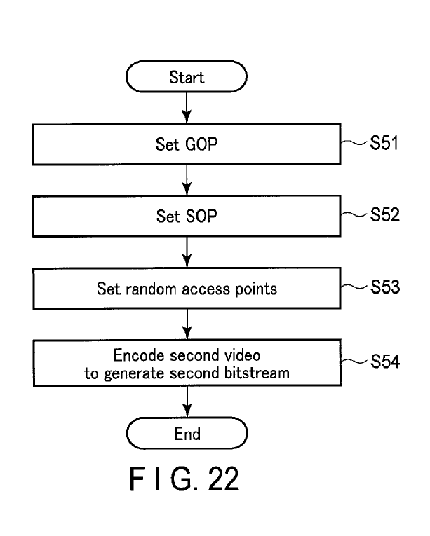

The compressor 250 operates as shown in FIG. 22. When the compressor 250 receives the second video 14, the second prediction structure information 18, and the reverse-converted video 19, video compression processing shown in FIG. 22 starts.

The compressor 250 sets a GOP size and an SOP size in accordance with the second prediction structure information 18 (steps S51 and S52). If a compression target picture corresponds to a random access point defined in the second prediction structure information 18, the compressor 250 sets the compression target picture as a random access point (step S53).

The compressor 250 compresses the second video 14 based on the reverse-converted video 19, thereby generating the second bitstream 20 (step S54). After step S54, the video compression processing shown in FIG. 22 ends. Note that since the second video 14 is a moving picture, the video compression processing shown in FIG. 22 is performed for each picture included in the second video 14.

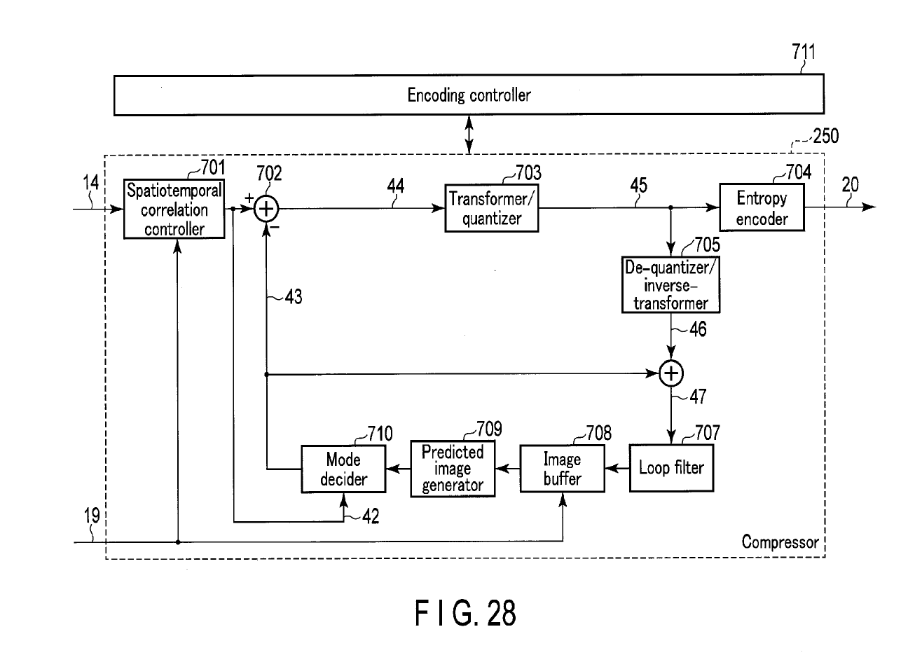

More specifically, as shown in FIG. 28, the compressor 250 includes a spatiotemporal correlation controller 701, a subtractor 702, a transformer/quantizer 703, an entropy encoder 704, a de-quantizer/inverse-transformer 705, an adder 706, a loop filter 707, an image buffer 708, a predicted image generator 709, and a mode decider 710. The compressor 250 shown in FIG. 28 is controlled by an encoding controller 711 that is not illustrated in FIG. 2.

The spatiotemporal correlation controller 701 receives the second video 14 from the delay circuit 231, and receives the reverse-converted video 19 from the video reverse-converter 240. The spatiotemporal correlation controller 701 applies, to the second video 14, filter processing for raising the spatiotemporal correlation between the reverse-converted video 19 and the second video 14, thereby generating a filtered image 42. The spatiotemporal correlation controller 701 outputs the filtered image 42 to the subtractor 702 and the mode decider 710.

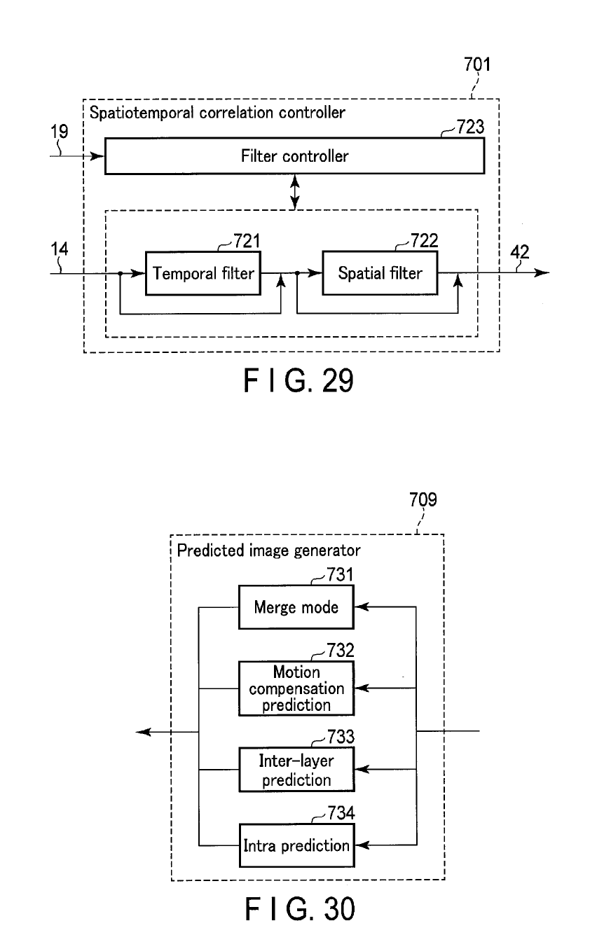

More specifically, as shown in FIG. 29, the spatiotemporal correlation controller 701 includes a temporal filter 721, a spatial filter 722, and a filter controller 723.

The temporal filter 721 receives the second video 14 and applies filter processing in the temporal direction using motion compensation to the second video 14. With the filter processing in the temporal direction, low-correlation noise in the temporal direction included in the second video 14 is reduced. For example, the temporal filter 721 can perform block matching for two or three frames before and after a filtering target image block, and perform the filter processing using an image block whose difference is equal to or smaller than a threshold. The filter processing can be e filter processing considering edges or normal low-pass filter processing. Since the correlation in the temporal direction is raised by applying a low-pass filter in the temporal direction, increase of compression performance can be achieved.

In particular, if the second video 14 is a high-resolution video, reduction of pixel size on image sensors results in increase of various type of noise. When post-production processing (grading processing) such as image emphasis or color correction processing is applied to the second video 14, ringing artifact (noise along sharp edges) is enhanced. If the second video 14 is compressed with the noise intact, subjective image quality degrades because a considerable amount of codes are assigned to faithfully reproduce the noise. When the noise is reduced by the temporal filter 721, the subjective image quality can be improved while maintaining the size of compressed video data.

The temporal filter 721 can also be bypassed. Enabling/disabling the temporal filter 721 can be controlled by the filter controller 723. More specifically, if correlation in the temporal direction on the periphery of a filtering target image block is low (for example, the correlation coefficient in the temporal direction is equal to or smaller than a threshold), or a scene change occurs, the filter controller 723 can disable the temporal filter 721.

The spatial filter 722 receives the second video 14 (or a filtered image filtered by the temporal filter 721), and performs filter processing of controlling the spatial correlation in the frame of each image included in the second video 14. More specifically, the spatial filter 722 performs filter processing of making the second video 14 close to the reverse-converted video 19 so as to suppress alienation of the spatial frequency characteristic between the reverse-converted video 19 and the second video 14. The spatial filter 722 can be implemented using low-pass filter processing or another more complex processing (for example, bilateral filter, sample adaptive offset, or Wiener filter).

As will be described later, the compressor 250 can use inter-layer prediction and motion compensation prediction. However, predicted images generated by these prediction may have largely different tendencies. If a data amount (target bit rate) usable by the second bitstream 20 is large enough with respect to the data amount of the second video 14, influence on the subjective image quality is limited because the data amount reduced by quantization processing performed by the transformer/quantizer 703 is relatively small even if predicted images generated by inter-layer prediction and motion compensation prediction have largely different tendencies. On the other hand, if a data amount usable by the second bitstream 20 is not large enough with respect to the data amount of the second video 14, a decoded image generated based on inter-layer prediction and a decoded image generated based on motion compensation prediction may have largely different tendencies, and the subjective image quality may degrade. Such degradation in subjective image quality can be suppressed by making the spatial characteristic of the second video 14 close to that of the reverse-converted video 19 using the spatial filter 722.

The filter intensity of the spatial filter 722 need not be fixed and can dynamically be controlled by the filter controller 723. The filter intensity of the spatial filter 722 can be controlled based on, for example, three indices, that is, the target bit rate of the second bitstream 20, the compression difficulty of the second video 14, and the image quality of the reverse-converted video 19. More specifically, the lower the target bit rate of the second bitstream 20 is, the higher the filter intensity of the spatial filter 722 can be controlled to be. The higher the compression difficulty of the second video 14 is, the higher the filter intensity of the spatial filter 722 can be controlled to be. The lower the image quality of the reverse-converted video 19 is, the higher the filter intensity of the spatial filter 722 can be controlled to be.

Note that the spatial filter 722 can also be bypassed. Enabling/disabling the spatial filter 722 can be controlled by the filter controller 723. More specifically, if the spatial resolution of a filtering target image is not high, or a filter intensity derived based on the above-described three indices is minimum, the filter controller 723 can disable the spatial filter 722.

The criterion amount used to determine whether a data amount usable by the second bitstream 20 is large enough with respect to the data amount of the second video 14 is about 10 Mbps (compression ratio=190:1) if, for example, the video format of the second video 14 is defined as 1920×1080 pixels, YUV 4:2:0, 8 bit depth, and 60 fps (corresponding to 1.9 Gbps), and the codec is HEVC. In this example, if the resolution of the second video 14 is extended to 3840×2160 pixels, the criterion amount is about 40 Mbps.

The filter controller 723 controls enabling/disabling of the temporal filter 721 and enabling/disabling and intensity of the spatial filter 722.

The subtractor 702 receives the filtered image 42 from the spatiotemporal correlation controller 701 and a predicted image 43 from the mode decider 710. The subtractor 702 subtracts the predicted image 43 from the filtered image 42, thereby generating a prediction error 44. The subtractor 702 outputs the prediction error 44 to the transformer/quantizer 703.

The transformer/quantizer 703 applies orthogonal transform, for example, DCT (Discrete Cosine Transform) to the prediction error 44, thereby obtaining a transform coefficient. The transformer/quantizer 703 further quantizes the transform coefficient, thereby obtaining quantized transform coefficients 45. Quantization can be implemented by processing of, for example, dividing the transform coefficient by an integer corresponding to the quantization width. The transformer/quantizer 703 outputs the quantized transform coefficients 45 to the entropy encoder 704 and the de-quantizer/inverse-transformer 705.

The entropy encoder 704 receives the quantized transform coefficients 45 from the transformer/quantizer 703. The entropy encoder 704 binarizes and variable-length-encodes parameters (quantization information, prediction mode information, and the like) necessary for decoding in addition to the quantized transform coefficients 45, thereby generating the second bitstream 20. The structure of the second bitstream 20 complies with the specifications of the codec (for example, SHVC) used by the compressor 250.

The de-quantizer/inverse-transformer 705 receives the quantized transform coefficients 45 from the transformer/quantizer 703. The de-quantizer/inverse-transformer 705 de-quantizes the quantized transform coefficients 45, thereby obtaining a restored transform coefficient. The de-quantizer/inverse-transformer 705 further applies inverse orthogonal transform, for example, IDCT (Inverse DCT) to the restored transform coefficient, thereby obtaining a restored prediction error 46. De-quantization can be implemented by processing of, for example, multiplying the restored transform coefficient by an integer corresponding to the quantization width. The de-quantizer/inverse-transformer 705 outputs the restored prediction error 46 to the adder 706.

The adder 706 receives the predicted image 43 from the mode decider 710, and receives the restored prediction error 46 from the de-quantizer/inverse-transformer 705. The adder 706 adds the predicted image 43 and the restored prediction error 46, thereby generating a local decoded image 47. The adder 706 outputs the local decoded image 47 to the loop filter 707.

The loop filter 707 receives the local decoded image 47 from the adder 706. The loop filter 707 performs filter processing for the local decoded image 47, thereby generating a filtered image. The filter processing can be, for example, deblocking filter processing or sample adaptive offset. The loop filter 707 outputs the filtered image to the image buffer 708.

The image buffer 708 receives the reverse-converted video 19 from the video reverse-converter 240, and receives the filtered image from the loop filter 707. The image buffer 708 saves the reverse-converted video 19 and the filtered image as reference images. The reference images saved in the image buffer 708 are output to the predicted image generator 709 as needed.

The predicted image generator 709 receives the reference images from the image buffer 708. The predicted image generator 709 can use various prediction modes, for example, intra prediction, motion compensation prediction, inter-layer prediction, and merge mode (to be described later). For each of one or more prediction modes, the predicted image generator 709 generates a predicted image on a block basis based on the reference images. The predicted image generator 709 outputs the at least one generated predicted image to the mode decider 710.

More specifically, as shown in FIG. 30, the predicted image generator 709 can include a merge mode processor 731, a motion compensation prediction processor 732, an inter-layer prediction processor 733, and an intra prediction processor 734.

The merge mode processor 731 performs prediction in accordance with a merge mode defined in HEVC. The merge mode is a kind of motion compensation prediction. As motion information (for example, motion vector information and the indices of reference images) of a compression target block, motion information of a compressed block close to the compression target block in the spatiotemporal direction is copied. According to the merge mode, since the motion information itself of the compression target block is not encoded, overhead is suppressed as compared to normal motion compensation prediction. On the other hand, in a video including, for example, zoom-in, zoom-out, or accelerating camera motion, the motion information of the compression target block is hardly similar to the motion information of a compressed block in the neighborhood. For this reason, if merge mode processing is selected for such a video, subjective image quality lowers particularly in a case where a sufficient bit rate cannot be ensured.

The motion compensation prediction processor 732 performs a motion search of a compression target block by referring to a local decoded image (reference image) at a temporal position (that is, display order) different from that of the compression target block, and generates a predicted image based on the found motion information. According to the motion compensation prediction, the predicted image is generated from the reference image at the temporal position different from that of the compression target block. Hence, in a case where, for example, a moving object represented by the compression target block deforms along with the elapse of time, or the average brightness in a frame varies along with the elapse of time, the subjective image quality may degrade because it is difficult to attain a high prediction accuracy.

The inter-layer prediction processor 733 copies a reference image block (that is, a block in a reference image at the same temporal position and spatial position as the compression target block) corresponding to the compression target block by referring to the reverse-converted video 19 (reference image), thereby generating a predicted image. If the image quality of the reverse-converted video 19 is stable, subjective image quality when inter-layer prediction is selected also stabilizes.

The intra prediction processor 734 generates a predicted image by referring to a compressed pixel line (reference image) adjacent to the compression target block in the same frame as the compression target block.

The mode decider 710 receives the filtered image 42 from the spatiotemporal correlation controller 701, and receives at least one predicted image from the predicted image generator 709. The mode decider 710 calculates the encoding cost of each of one or more prediction modes used by the predicted image generator 709 using at least the filtered image 42, and selects a prediction mode that minimizes the encoding cost. The mode decider 710 outputs a predicted image corresponding to the selected prediction mode to the subtractor 702 and the adder 706 as the predicted image 43.

For example, the mode decider 710 can calculate an encoding cost K by

K=SAD+λ×OH (1)

where SAD is the sum of absolute differences between the filtered image 42 and the predicted image 43 (that is, the sum of absolutes of the prediction error 44), λ is a Lagrange's undetermined multiplier defined based on quantization parameters, and OH is the code amount of predicted information (for example, motion vector and predicted block size) when the target prediction mode is selected.

Note that equation (1) can be variously modified. For example, the mode decider 710 may set K=SAD or K=OH or use a value obtained by applying Hadamard transform to SAD or an approximate value thereof.

Alternatively, the mode decider 710 may calculate an encoding cost J by

J=D+λ×R (2)

where D is the sum of squared differences (that is, encoding distortion) between the filtered image 42 and a local decoded image corresponding to the target prediction mode, and R is a code amount generated when a prediction error corresponding to the target prediction mode is temporarily encoded.

To calculate the encoding cost J, it is necessary to perform temporary encoding processing and local decoding processing for each prediction mode. Hence, the circuit scale or operation amount increases. On the other hand, according to the encoding cost J, the encoding cost can appropriately be evaluated as compared to the encoding cost K, and it is therefore possible to stably achieve a high encoding efficiency.

Note that equation (2) can variously be modified. For example, the mode decider 710 may set J=D or J=R or use an approximate value of D or R.

Comparing inter-layer prediction with motion compensation prediction, if the encoding costs of those processes are almost equal, subjective image quality is likely to stabilize when inter-layer prediction is selected. Hence, the mode decider 710 may weight the encoding cost by, for example,

$$\{ \begin{matrix}J = D + λ \times R ; & In a case where prediction mode = inter \text{-} layer prediction \\ J = ( D + λ \times R ) \times w ; & In other case\end{matrix} \qquad ( 3 )$$

such that inter-layer prediction is selected with priority over other predictions (particularly, motion compensation prediction).

In equation (3), w is a weight coefficient that is set to a value (for example, 1.5) larger than 1. That is, if the encoding cost of inter-layer prediction almost equals the encoding costs of other prediction modes before weighting, the mode decider 710 selects inter-layer prediction.

Note that the weighting represented by equation (3) may be performed only in a case where, for example, the encoding cost J of motion compensation prediction or inter-layer prediction is equal to or larger than a threshold. If the encoding cost of motion compensation prediction is (considerably) high, motion compensation mode may be inappropriate for the target block and thereby it may lead to motion shift or artifacts. On the other hand, since inter-layer prediction uses a reference image block of the same temporal position, these (motion-related) artifacts don't essentially occur. Hence, when the inter-layer prediction is applied to the compression target block for which motion compensation prediction is inappropriate, degradation in subjective image quality (for example, image quality degradation in the temporal direction) is easily suppressed. The weighting represented by equation (3) is thus applied conditionally. This makes it possible to fairly evaluate each prediction mode for a compression target block for which motion compensation prediction is appropriate and evaluate each prediction mode so as to preferentially select the inter-layer prediction mode for a compression target block for which motion compensation prediction is inappropriate.

The encoding controller 711 controls the compressor 250 in the above-described way. More specifically, the encoding controller 711 can control the quantization (for example, the magnitude of the quantization parameter) performed by the transformer/quantizer 703. This control is equivalent to adjusting a data amount to be reduced by quantization processing, and contributes to rate control. The encoding controller 711 may control the output timing of the second bitstream 20 (that is, control CPB (Coded Picture Buffer)) or control the occupation amount in the image buffer 708. The encoding controller 711 may also control the prediction structure of the second bitstream 20 in accordance with the second prediction structure information 18.

The data multiplexer 260 receives the video synchronizing signal 11 from the video storage apparatus 110, receives the first bitstream 15 from the first video compressor 220, and receives the second bitstream 20 from the second video compressor 230. The video synchronizing signal 11 represents the playback timing of each frame included in the baseband video 10. The data multiplexer 260 generates reference information 22 and synchronizing information 23 (to be described later) based on the video synchronizing signal 11.

The reference information 22 represents a reference clock value used to synchronize a system clock incorporated in the video playback apparatus 300 with a system clock incorporated in the video compression apparatus 200. In other words, system clock synchronization between the video compression apparatus 200 and the video playback apparatus 300 is implemented via the reference information 22.

The synchronizing information 23 is information representing the playback time or decoding time of the first bitstream 15 and the second bitstream 20 in terms of the system clock. Hence, if the system clocks of the video compression apparatus 200 and the video playback apparatus 300 do not synchronize, the video playback apparatus 300 decodes and plays a video at a timing different from a timing set by the video compression apparatus 200.

In addition, the data multiplexer 260 multiplexes the first bitstream 15, the second bitstream 20, the reference information 22, and the synchronizing information 23, thereby generating the multiplexed bitstream 12. The data multiplexer 260 outputs the multiplexed bitstream 12 to the video transmission apparatus 120.

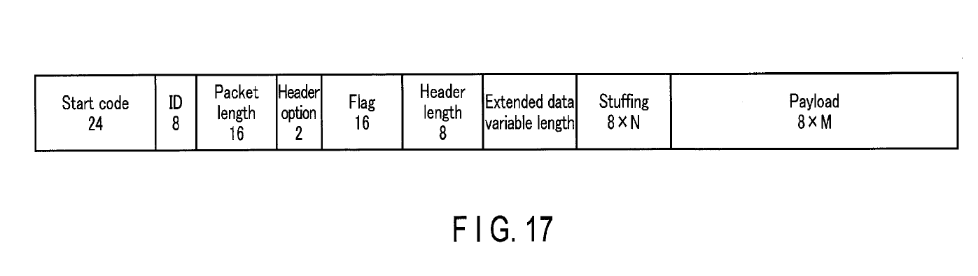

The multiplexed bitstream 12 may be generated by, for example, multiplexing a variable length packet called a PES (Packetized Elementary Stream) packet defined in the MPEG-2 system. The PES packet has a data format shown in FIG. 17. In the flag and extended data fields shown in FIG. 17, for example, a PES priority representing the priority of the PES packet, information representing whether there is a designation of the playback (display) time or decoding time of a video or audio, information representing whether to use an error detecting code, and the like are described.

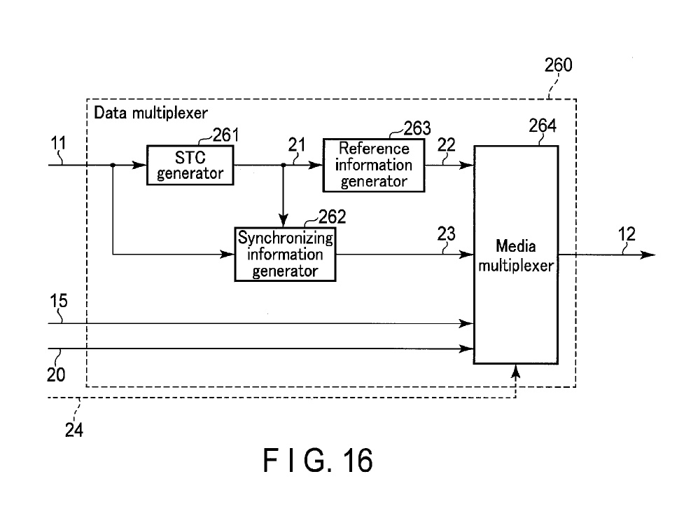

More specifically, as shown in FIG. 16, the data multiplexer 260 can include an STC (System Time Clock) generator 261, a synchronizing information generator 262, a reference information generator 263, and a media multiplexer 264. Note that the data multiplexer 260 shown in FIG. 16 uses MPEG-2 TS (Transport Stream) as a multiplexing format. However, an existing media container defined by MP4, MPEG-DASH, MMT, ASF, or the like may be used in place of MPEG-2 TS.

The STC generator 261 receives the video synchronizing signal 11 from the video storage apparatus 110, and generates an STC signal 21 in accordance with the video synchronizing signal 11. The STC signal 21 represents the count value of the STC. The operating frequency of the STC is defined as 27 MHz in the MPEG-2 TS. The STC generator 261 outputs the STC signal 21 to the synchronizing information generator 262 and the reference information generator 263.

The synchronizing information generator 262 receives the video synchronizing signal 11 from the video storage apparatus 110, and receives the STC signal 21 from the STC generator 261. The synchronizing information generator 262 generates the synchronizing information 23 based on the STC signal 21 corresponding to the playback time or decoding time of a video or audio. The synchronizing information generator 262 outputs the synchronizing information 23 to the media multiplexer 264. The synchronizing information 23 corresponds to, for example, PTS (Presentation Time Stamp) or DTS (Decoding Time Stamp). If the STC signal internally reproduced matches the DTS, the video playback apparatus 300 decodes the corresponding unit. If the STC signal matches the PTS, the video playback apparatus 300 reproduces (displays) the corresponding decoded unit.

The reference information generator 263 receives the STC signal 21 from the STC generator 261. The reference information generator 263 intermittently generates the reference information 22 based on the STC signal 21, and outputs it to the media multiplexer 264. The reference information 22 corresponds to, for example, PCR (Program Clock Reference). The transmission interval of the reference information 22 is associated with the accuracy of system clock synchronization between the video compression apparatus 200 and the video playback apparatus 300.

The media multiplexer 264 receives the first bitstream 15 from the first video compressor 220, receives the second bitstream 20 from the second video compressor 230, receives the synchronizing information 23 from the synchronizing information generator 262, and receives the reference information 22 from the reference information generator 263. The media multiplexer 264 multiplexes the first bitstream 15, the second bitstream 20, the reference information 22, and the synchronizing information 23 in accordance with a predetermined format, thereby generating the multiplexed bitstream 12. The media multiplexer 264 outputs the multiplexed bitstream 12 to the video transmission apparatus 120. Note that the media multiplexer 264 may embed, in the multiplexed bitstream 12, an audio bitstream 24 corresponding to audio data compressed by an audio compressor (not shown).

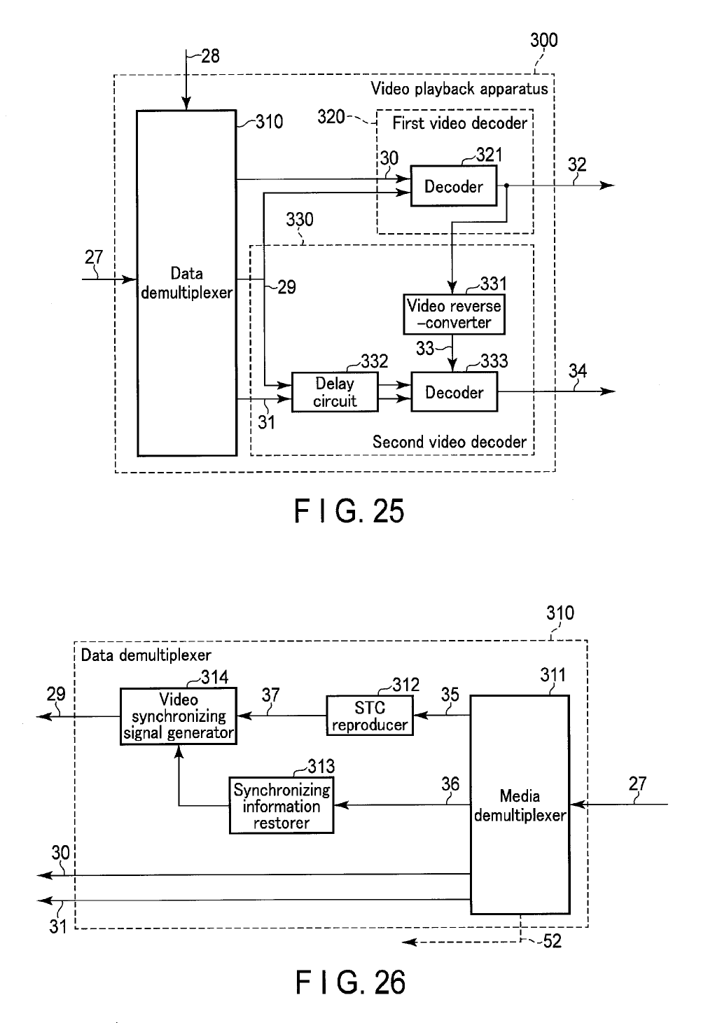

As shown in FIG. 25, the video playback apparatus 300 includes a data demultiplexer 310, a first video decoder 320, and a second video decoder 330. The video playback apparatus 300 receives a multiplexed bitstream 27 from the video receiving apparatus 140, and demultiplexes the multiplexed bitstream 27, thereby obtaining a plurality of layers (in the example of FIG. 25, two layers) of bitstreams. The video playback apparatus 300 decodes the plurality of layers of bitstreams, thereby playing a first decoded video 32 and a second decoded video 34. The video playback apparatus 300 outputs the first decoded video 32 and the second decoded video 34 to the display apparatus 150.

The data demultiplexer 310 receives the multiplexed bitstream 27 from the video receiving apparatus 140, and demultiplexes the multiplexed bitstream 27, thereby extracting a first bitstream 30, a second bitstream 31, and various kinds of control information. The multiplexed bitstream 27, the first bitstream 30, and the second bitstream 31 correspond to the multiplexed bitstream 12, the first bitstream 15, and the second bitstream 20 described above, respectively.

In addition, the data demultiplexer 310 generates a video synchronizing signal 29 representing the playback timing of each frame included in the first decoded video 32 and the second decoded video 34 based on the control information extracted from the multiplexed bitstream 27. The data demultiplexer 310 outputs the video synchronizing signal 29 and the first bitstream 30 to the first video decoder 320, and outputs the video synchronizing signal 29 and the second bitstream 31 to the second video decoder 330.

More specifically, as shown in FIG. 26, the data demultiplexer 310 can include a media demultiplexer 311, an STC reproducer 312, a synchronizing information restorer 313, and a video synchronizing signal generator 314. The data demultiplexer 310 performs processing reverse to that of the data multiplexer 260 shown in FIG. 16.

The media demultiplexer 311 receives the multiplexed bitstream 27 from the video receiving apparatus 140. The media demultiplexer 311 demultiplexes the multiplexed bitstream 27 in accordance with a predetermined format, thereby extracting the first bitstream 30, the second bitstream 31, reference information 35, and synchronizing information 36. The reference information 35 and the synchronizing information 36 correspond to the reference information 22 and the synchronizing information 23 described above, respectively. The media demultiplexer 311 outputs the first bitstream 30 to the first video decoder 320, outputs the second bitstream 31 to the second video decoder 330, outputs the reference information 35 to the STC reproducer 312, and outputs the synchronizing information 36 to the synchronizing information restorer 313. Note that the media demultiplexer 311 may extract an audio bitstream 52 from the multiplexed bitstream 27 and output it to an audio decoder (not shown).

The STC reproducer 312 receives the reference information 35 from the media demultiplexer 311, and reproduces an STC signal 37 synchronized with the video compression apparatus 200 using the reference information 35 as a reference clock value. The STC reproducer 312 outputs the STC signal 37 to the synchronizing information restorer 313 and the video synchronizing signal generator 314.

The synchronizing information restorer 313 receives the synchronizing information 36 from the media demultiplexer 311. The synchronizing information restorer 313 derives the decoding time or playback time of the video based on the synchronizing information 36. The synchronizing information restorer 313 notifies the video synchronizing signal generator 314 of the derived decoding time or playback time.

The video synchronizing signal generator 314 receives the STC signal 37 from the STC reproducer 312, and is notified of the decoding time or playback time of the video by the synchronizing information restorer 313. The video synchronizing signal generator 314 generates the video synchronizing signal 29 based on the STC signal 37 and the notified decoding time or playback time. The video synchronizing signal generator 314 adds the video synchronizing signal 29 to each of the first bitstream 30 and the second bitstream 31, and outputs them to the first video decoder 320 and the second video decoder 330, respectively.

The first video decoder 320 receives the video synchronizing signal 29 and the first bitstream 30 from the data demultiplexer 310. The first video decoder 320 decodes (decompresses) the first bitstream 30 in accordance with the timing represented by the video synchronizing signal 29, thereby generating the first decoded video 32. The codec used by the first video decoder 320 is the same as that used to generate the first bitstream 30, and can be, for example, MPEG-2. The first video decoder 320 outputs the first decoded video 32 to the display apparatus 150 and a video reverse-converter 331. The first video decoder 320 includes a decoder 321. The decoder 321 partially or wholly performs the operation of the first video decoder 320.

Note that if the first bitstream 30 and the second bitstream 31 have the same prediction structure, and picture reordering is needed, the first video decoder 320 preferably directly outputs decoded pictures to the video reverse-converter 331 as the first decoded video 32 in the decoding order without reordering. By outputting the first decoded video 32 in this way, the second video decoder 330 can immediately decode a picture of an arbitrary time in the second bitstream 31 after decoding of a picture of the same time in the first bitstream 30 is completed. However, if the first decoded video 32 is displayed by the display apparatus 150, picture reordering needs to be performed. For this reason, for example, enabling/disabling of picture reordering may be switched in synchronism with whether the display apparatus 150 displays the first decoded video 32.

The second video decoder 330 receives the video synchronizing signal 29 and the second bitstream 31 from the data demultiplexer 310, and receives the first decoded video 32 from the first video decoder 320. The second video decoder 330 decodes the second bitstream 31 in accordance with the timing represented by the video synchronizing signal 29, thereby generating the second decoded video 34. The second video decoder 330 outputs the second decoded video 34 to the display apparatus 150.

The second video decoder 330 includes the video reverse-converter 331, a delay circuit 332, and a decoder 333.

The video reverse-converter 331 receives the first decoded video 32 from the first video decoder 320. The video reverse-converter 331 applies video reverse-conversion to the first decoded video 32, thereby generating a reverse-converted video 33. The video reverse-converter 331 outputs the reverse-converted video 33 to the decoder 333. The video format of the reverse-converted video 33 matches that of the second decoded video 34. That is, if the baseband video 10 and the second decoded video 34 have the same video format, the video reverse-converter 331 performs conversion reverse to that of the video converter 210. Note that if the video format of the first decoded video 32 (that is, first video 13) is the same as the video format of the second decoded video 34, the video reverse-converter 331 may select pass-through. The video reverse-converter 331 can perform processing that is the same as or similar to the processing of the video reverse-converter 240 shown in FIG. 2.

The delay circuit 332 receives the video synchronizing signal 29 and the second bitstream 31 from the data demultiplexer 310, temporarily holds them, and then transfers them to the decoder 333. The delay circuit 332 controls the output timing of the video synchronizing signal 29 and the second bitstream 31 based on the video synchronizing signal 29 such that the video synchronizing signal 29 and the second bitstream 31 are input to the decoder 333 in synchronism with the reverse-converted video 33 to be described later. In other words, the delay circuit 332 functions as a buffer that absorbs a processing delay caused by the first video decoder 320 and the video reverse-converter 331. Note that the buffer corresponding to the delay circuit 332 may be incorporated in, for example, the data demultiplexer 310 in place of the second video decoder 330.

The decoder 333 receives the video synchronizing signal 29 and the second bitstream 31 from the delay circuit 332, and receives the reverse-converted video 33 from the video reverse-converter 331. The decoder 333 decodes the second bitstream 31 based on the reverse-converted video 33 in accordance with the timing represented by the video synchronizing signal 29, thereby playing the second decoded video 34. The decoder 333 uses the same codec that used to generate the second bitstream 31, and can be, for example, SHVC. The decoder 333 outputs the second decoded video 34 to the display apparatus 150.

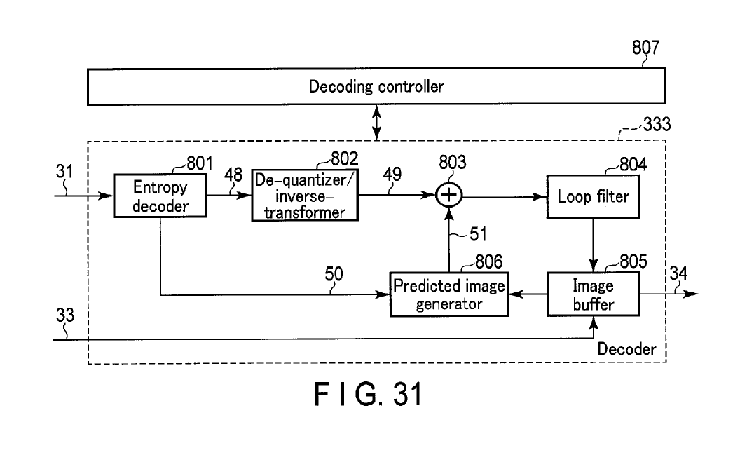

More specifically, as shown in FIG. 31, the decoder 333 can include an entropy decoder 801, a de-quantizer/inverse-transformer 802, an adder 803, a loop filter 804, an image buffer 805, and a predicted image generator 806. The decoder 333 shown in FIG. 31 is controlled by a decoding controller 807 that is not illustrated in FIG. 25.

The entropy decoder 801 receives the second bitstream 31. The entropy decoder 801 entropy-decodes a binary data sequence as the second bitstream 31, thereby extracting various kinds of information (for example, quantized transform coefficients 48 and prediction mode information 50) complying with the data format of SHVC. The entropy decoder 801 outputs the quantized transform coefficients 48 to the de-quantizer/inverse-transformer 802, and outputs the prediction mode information 50 to the predicted image generator 806.

The de-quantizer/inverse-transformer 802 receives the quantized transform coefficients 48 from the entropy decoder 801. The de-quantizer/inverse-transformer 802 de-quantizes the quantized transform coefficients 48, thereby obtaining a restored transform coefficient. The de-quantizer/inverse-transformer 802 further applies inverse orthogonal transform, for example, IDCT to the restored transform coefficient, thereby obtaining a restored prediction error 49. The de-quantizer/inverse-transformer 802 outputs the restored prediction error 49 to the adder 803.

The adder 803 receives the restored prediction error 49 from the de-quantizer/inverse-transformer 802, and receives a predicted image 51 from the predicted image generator 806. The adder 803 adds the restored prediction error 49 and the predicted image 51, thereby generating a decoded image. The adder 803 outputs the decoded image to the loop filter 804.

The loop filter 804 receives the decoded image from the adder 803. The loop filter 804 performs filter processing for the decoded image, thereby generating a filtered image. The filter processing can be, for example, deblocking filter processing or sample adaptive offset processing. The loop filter 804 outputs the filtered image to the image buffer 805.

The image buffer 805 receives the reverse-converted video 33 from the video reverse-converter 331, and receives the filtered image from the loop filter 804. The image buffer 805 saves the reverse-converted video 33 and the filtered image as reference images. The reference images saved in the image buffer 805 are output to the predicted image generator 806 as needed. In addition, the filtered image saved in the image buffer 805 is output to the display apparatus 150 as the second decoded video 34 in accordance with the timing represented by the video synchronizing signal 29.

The predicted image generator 806 receives the prediction mode information 50 from the entropy decoder 801, and receives the reference images from the image buffer 805. The predicted image generator 806 can use various prediction modes, for example, intra prediction, motion compensation prediction, inter-layer prediction, and merge mode described above. In accordance with the prediction mode represented by the prediction mode information 50, the predicted image generator 806 generates the predicted image 51 on a block basis based on the reference images. The predicted image generator 806 outputs the predicted image 51 to the adder 803.

The decoding controller 807 controls the decoder 333 in the above-described way. More specifically, the decoding controller 807 can control the input timing of the second bitstream 20 (that is, control CPB) or control the occupation amount in the image buffer 805.

When the user performs some operation on, for example, the display apparatus 150, a user request 28 according to the operation contents is input to the data demultiplexer 310 or the video receiving apparatus 140. For example, if the display apparatus 150 is a TV set, the user can switch the channel by operating a remote controller serving as the input I/F 154. The user request 28 can be transmitted by the communicator 155 or directly output from the input I/F 154 as unique operation information.

When channel switching occurs, the data demultiplexer 310 receives a new multiplexed bitstream, and the first video decoder 320 and the second video decoder 330 perform random access. The first video decoder 320 and the second video decoder 330 can generally correctly decode pictures on and after the first random access point after the channel switching but cannot necessarily correctly decode pictures immediately after the channel switching. The second bitstream 31 cannot correctly be decoded until the first bitstream 30 is correctly decoded. Hence, if the first random access point in the first bitstream 30 after the channel switching does not match the first random access point in the second bitstream 31 on or after the random access point, decoding of the second bitstream 31 delays by an amount corresponding to the difference between them. As described with reference to FIGS. 12 and 13, the video compression apparatus 200 controls the prediction structure (random access points) of the second bitstream 20, thereby limiting the upper limit of the decoding delay of the second bitstream 31 to an amount corresponding to the SOP size of the second bitstream 31. Hence, even if random access occurs due to, for example, channel switching, the display apparatus 150 can start displaying the second decoded video 34 corresponding to a high-quality enhancement layer video early.

As described above, the video compression apparatus included in the video delivery system according to the first embodiment controls the prediction structure of the second bitstream corresponding to an enhancement layer video based on the prediction structure of the first bitstream corresponding to a base layer video. More specifically, the video compression apparatus selects, from the second bitstream, the earliest SOP on or after a random access point in the first bitstream in display order. Then, the video compression apparatus sets the earliest picture of the selected SOP in coding order as a random access point for the second bitstream. Hence, according to the video compression apparatus, it is possible to suppress the decoding delay of the second bitstream in a case where the video playback apparatus has performed random access while avoiding lowering the compression efficiency and increasing the compression delay and the device cost.

In addition, the video compression apparatus and the video playback apparatus compress/decode a plurality of layered videos using individual codecs, thereby ensuring the compatibility with an existing video playback apparatus. For example, if MPEG-2 is used for the first bitstream corresponding to the base layer video, an existing video playback apparatus that supports MPEG-2 can decode and reproduce the first bitstream. Furthermore, if SHVC (that is, scalable compression) is used for the second bitstream corresponding to the enhancement layer video, the compression efficiency can largely be improved as compared to a case where simultaneous compression is used.

### Second Embodiment

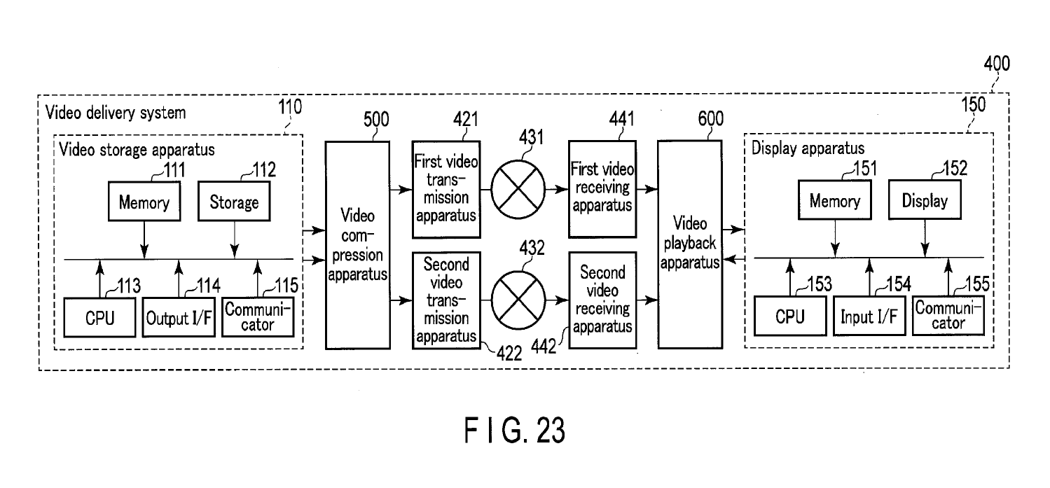

As shown in FIG. 23, a video delivery system 400 according to the second embodiment includes a video storage apparatus 110, a video compression apparatus 500, a first video transmission apparatus 421 and a second video transmission apparatus 422, a first channel 431 and a second channel 432, a first video receiving apparatus 441 and a second video receiving apparatus 442, a video playback apparatus 600, and a display apparatus 150.

The video compression apparatus 500 receives a baseband video from the video storage apparatus 110, and compresses the baseband video using a scalable compression function, thereby generating a plurality of multiplexed bitstreams in which a plurality of layers of compressed video data are individually multiplexed. The video compression apparatus 500 outputs a first multiplexed bitstream to the first video transmission apparatus 421, and outputs a second multiplexed bitstream to the second video transmission apparatus 422.

The first video transmission apparatus 421 receives the first multiplexed bitstream from the video compression apparatus 500, and transmits the first multiplexed bitstream to the first video receiving apparatus 441 via the first channel 431. For example, if the first channel 431 corresponds to a transmission band of terrestrial digital broadcasting, the first video transmission apparatus 421 can be an RF transmission apparatus. If the first channel 431 corresponds to a network line, the first video transmission apparatus 421 can be an IP communication apparatus.

The second video transmission apparatus 422 receives the second multiplexed bitstream from the video compression apparatus 500, and transmits the second multiplexed bitstream to the second video receiving apparatus 442 via the second channel 432. For example, if the second channel 432 corresponds to a transmission band of terrestrial digital broadcasting, the second video transmission apparatus 422 can be an RF transmission apparatus. If the second channel 432 corresponds to a network line, the second video transmission apparatus 422 can be an IP communication apparatus.

The first channel 431 is a network that connects the first video transmission apparatus 421 and the first video receiving apparatus 441. The first channel 431 means various communication resources usable for information transmission. The first channel 431 can be a wired channel, a wireless channel, or a mixture thereof. The first channel 431 may be, for example, the Internet, a terrestrial broadcasting network, a satellite broadcasting network, or a cable transmission network. The first channel 431 may be a channel for various kinds of communications, for example, radio wave communication, PHS, 3G, 4G, LTE, millimeter wave communication, and radar communication.

The second channel 432 is a network that connects the second video transmission apparatus 422 and the second video receiving apparatus 442. The second channel 432 means various communication resources usable for information transmission. The second channel 432 can be a wired channel, a wireless channel, or a mixture thereof. The second channel 432 may be, for example, the Internet, a terrestrial broadcasting network, a satellite broadcasting network, or a cable transmission network. The second channel 432 may be a channel for various kinds of communications, for example, radio wave communication, PHS, 3G, LTE, millimeter wave communication, and radar communication.

The first video receiving apparatus 441 receives the first multiplexed bitstream from the first video transmission apparatus 421 via the first channel 431. The first video receiving apparatus 441 outputs the received first multiplexed bitstream to the video playback apparatus 600. For example, if the first channel 431 corresponds to a transmission band of terrestrial digital broadcasting, the first video receiving apparatus 441 can be an RF receiving apparatus (including an antenna to receive terrestrial digital broadcasting). If the first channel 431 corresponds to a network line, the first video receiving apparatus 441 can be an IP communication apparatus (including a function corresponding to a router or the like used to connect an IP network).

The second video receiving apparatus 442 receives the second multiplexed bitstream from the second video transmission apparatus 422 via the second channel 432. The second video receiving apparatus 442 outputs the received second multiplexed bitstream to the video playback apparatus 600. For example, if the second channel 432 corresponds to a transmission band of terrestrial digital broadcasting, the second video receiving apparatus 442 can be an RF receiving apparatus (including an antenna to receive terrestrial digital broadcasting). If the second channel 432 corresponds to a network line, the second video receiving apparatus 442 can be an IP communication apparatus (including a function corresponding to a router or the like used to connect an IP network).

The video playback apparatus 600 receives the first multiplexed bitstream from the first video receiving apparatus 441, receives the second multiplexed bitstream from the second video receiving apparatus 442, and decodes the first multiplexed bitstream and the second multiplexed bitstream using the scalable compression function, thereby generating a decoded video. The video playback apparatus 600 outputs the decoded video to the display apparatus 150. The video playback apparatus 600 can be incorporated in a TV set main body or implemented as an STB separated from the TV set.

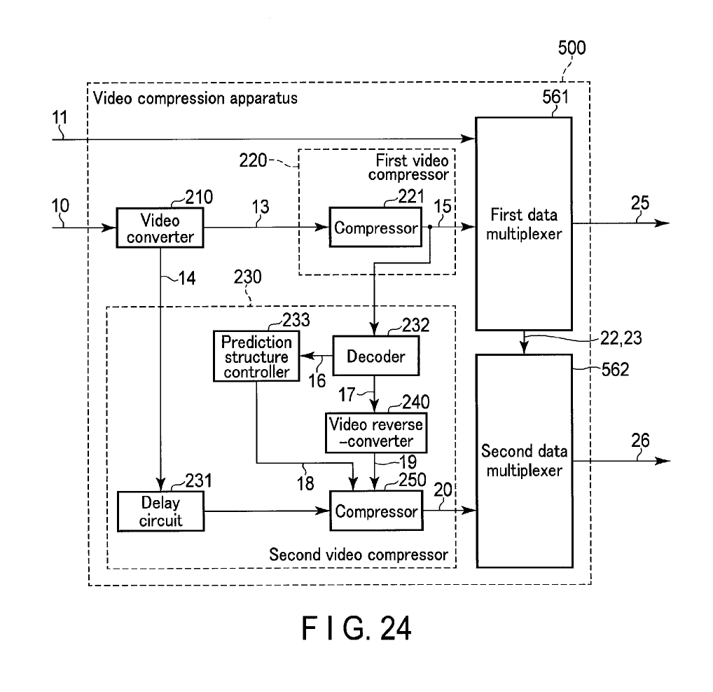

As shown in FIG. 24, the video compression apparatus 500 includes a video converter 210, a first video compressor 220, a second video compressor 230, a first data multiplexer 561, and a second data multiplexer 562. The video compression apparatus 500 receives a baseband video 10 and a video synchronizing signal 11 from the video storage apparatus 110, and compresses the baseband video 10 using the scalable compression function, thereby generating a plurality of layers (in the example of FIG. 24, two layers) of bitstreams. The video compression apparatus 500 individually multiplexes various kinds of control information generated based on the video synchronizing signal 11 and the plurality of layers of bitstreams, thereby generating a first multiplexed bitstream 25 and a second multiplexed bitstream 26. The video compression apparatus 500 outputs the first multiplexed bitstream 25 to the first video transmission apparatus 421, and outputs the second multiplexed bitstream 26 to the second video transmission apparatus 422.

The first video compressor 220 shown in FIG. 24 is different from the first video compressor 220 shown in FIG. 2 in that it outputs a first bitstream 15 to the first data multiplexer 561 in place of the data multiplexer 260. The second video compressor 230 shown in FIG. 24 is different from the second video compressor 230 shown in FIG. 2 in that it outputs a second bitstream 20 to the second data multiplexer 562 in place of the data multiplexer 260.

The first data multiplexer 561 receives the video synchronizing signal 11 from the video storage apparatus 110, and receives the first bitstream 15 from the first video compressor 220. The first data multiplexer 561 generates reference information 22 and synchronizing information 23 based on the video synchronizing signal 11. The first data multiplexer 561 outputs the reference information 22 and the synchronizing information 23 to the second data multiplexer 562. The first data multiplexer 561 also multiplexes the first bitstream 15, the reference information 22, and the synchronizing information 23, thereby generating the first multiplexed bitstream 25. The first data multiplexer 561 outputs the first multiplexed bitstream 25 to the first video transmission apparatus 421.

The second data multiplexer 562 receives the second bitstream 20 from the second video compressor 230, and receives the reference information 22 and the synchronizing information 23 from the first data multiplexer 561. The second data multiplexer 562 multiplexes the second bitstream 20, the reference information 22, and the synchronizing information 23, thereby generating the second multiplexed bitstream 26. The second data multiplexer 562 outputs the second multiplexed bitstream 26 to the second video transmission apparatus 422.

The first data multiplexer 561 and the second data multiplexer 562 can perform processing similar to that of the data multiplexer 260.

The first multiplexed bitstream 25 is transmitted via the first channel 431, and the second multiplexed bitstream 26 is transmitted via the second channel 432. A transmission delay in the first channel 431 may be different from the transmission delay in the second channel 432. However, the common reference information 22 and synchronizing information 23 are embedded in the first multiplexed bitstream 25 and the second multiplexed bitstream 26. For this reason, as in the first embodiment, system clock synchronization between the video compression apparatus 500 and the video playback apparatus 600 is obtained, and the video playback apparatus 600 can decode and play a video at a timing set by the video compression apparatus 500.

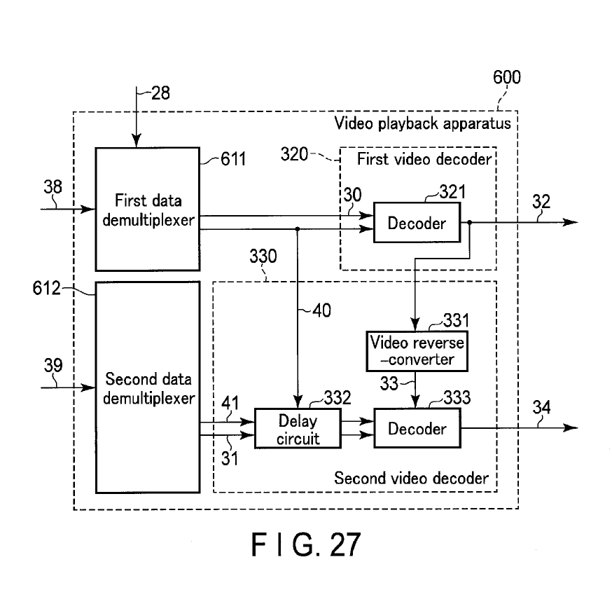

As shown in FIG. 27, the video playback apparatus 600 includes a first data demultiplexer 611, a second data demultiplexer 612, a first video decoder 320, and a second video decoder 330. The video playback apparatus 600 receives a first multiplexed bitstream 38 from the first video receiving apparatus 441, receives a second multiplexed bitstream 39 from the second video receiving apparatus 442, and individually demultiplexes the first multiplexed bitstream 38 and the second multiplexed bitstream 39, thereby obtaining a plurality of layers (in the example of FIG. 27, two layers) of bitstreams. The first multiplexed bitstream 38 and the second multiplexed bitstream 39 correspond to the first multiplexed bitstream 25 and the second multiplexed bitstream 26, respectively. The video playback apparatus 600 decodes the plurality of layers of bitstreams, thereby playing a first decoded video 32 and a second decoded video 34. The video playback apparatus 600 outputs the first decoded video 32 and the second decoded video 34 to the display apparatus 150.

The first data demultiplexer 611 receives the first multiplexed bitstream 38 from the first video receiving apparatus 441, and demultiplexes the first multiplexed bitstream 38, thereby extracting a first bitstream 30 and various kinds of control information. In addition, the first data demultiplexer 611 generates a first video synchronizing signal 40 representing the playback timing of each frame included in the first decoded video 32 based on the control information extracted from the first multiplexed bitstream 38. The first data demultiplexer 611 outputs the first bitstream 30 and the first video synchronizing signal 40 to the first video decoder 320, and outputs the first video synchronizing signal 40 to the second video decoder 330.

The second data demultiplexer 612 receives the second multiplexed bitstream 39 from the second video receiving apparatus 442, and demultiplexes the second multiplexed bitstream 39, thereby extracting a second bitstream 31 and various kinds of control information. In addition, the second data demultiplexer 612 generates a second video synchronizing signal 41 representing the playback timing of each frame included in the second decoded video 34 based on the control information extracted from the second multiplexed bitstream 39. The second data demultiplexer 612 outputs the second bitstream 31 and the second video synchronizing signal 41 to the second video decoder 330.

The first data demultiplexer 611 and the second data demultiplexer 612 can perform processing similar to that of the data demultiplexer 310.

The first video decoder 320 shown in FIG. 27 is different from the first video decoder 320 shown in FIG. 25 in that it receives the first video synchronizing signal 40 and the first bitstream 30 from the first data demultiplexer 611.

The second video decoder 330 shown in FIG. 27 is different from the second video decoder 330 shown in FIG. 25 in that it receives the first video synchronizing signal 40 from the first data demultiplexer 611, and receives the second video synchronizing signal 41 and the second bitstream 31 from the second data demultiplexer 612.

A delay circuit 332 shown in FIG. 27 receives the first video synchronizing signal 40 from the first data demultiplexer 611, and receives the second bitstream 31 and the second video synchronizing signal 41 from the second data demultiplexer 612. The delay circuit 332 temporarily holds the second bitstream 31 and the second video synchronizing signal 41, and then transfers them to a decoder 333. The delay circuit 332 controls the output timing of the second bitstream 31 and the second video synchronizing signal 41 based on the first video synchronizing signal 40 and the second video synchronizing signal 41 such that the second bitstream 31 and the second video synchronizing signal 41 are input to the decoder 333 in synchronism with a reverse-converted video 33. In other words, the delay circuit 332 functions as a buffer that absorbs a processing delay by the first video decoder 320 and the video reverse-converter 331. Note that the buffer corresponding to the delay circuit 332 may be incorporated in, for example, the second data demultiplexer 612 in place to the second video decoder 330.

The first multiplexed bitstream 38 is transmitted via the first channel 431, and the second multiplexed bitstream 39 is transmitted via the second channel 432. A transmission delay in the first channel 431 may be different from the transmission delay in the second channel 432. However, the common reference information and synchronizing information are embedded in the first multiplexed bitstream 38 and the second multiplexed bitstream 39. For this reason, as in the first embodiment, system clock synchronization between the video compression apparatus 500 and the video playback apparatus 600 is obtained, and the video playback apparatus 600 can decode and play a video at a timing set by the video compression apparatus 500.

Note that if a large transmission delay occurs temporarily in the second channel 432 due to, for example, packet loss, the display apparatus 150 may avoid breakdown of the displayed video by displaying the first decoded video 32 in place of the second decoded video 34.

For example, if the first channel 431 is an RF channel with a band guarantee, and the second channel 432 is an IP channel without a band guarantee, packet loss may occur in the second channel 432. In a case where although the first video receiving apparatus 441 has received the first multiplexed bitstream 38 at a scheduled time in the video delivery system 400, the second video receiving apparatus 442 does not receive the second multiplexed bitstream 39 even when the delay time from the scheduled time reaches T, and the second decoded video 34 is late for the playback time, the second video receiving apparatus 442 outputs bitstream delay information to the display apparatus 150 via the video playback apparatus 600. T represents the maximum reception delay time length of the second multiplexed bitstream 39 with respect to the first multiplexed bitstream 38. Upon receiving the bitstream delay information, the display apparatus 150 switches the video displayed on a display 152 from the second decoded video 34 to the first decoded video 32.

The maximum reception delay time length T can be designed based on various factors, for example, the maximum capacity of a video buffer incorporated in the display apparatus 150, the time necessary for decoding of the first bitstream 30 and the second bitstream 31, and the transmission delay time between the apparatuses. The maximum reception delay time length T need not be fixed and may dynamically be changed. Note that the video buffer incorporated in the display apparatus 150 may be implemented using, for example, a memory 151. In a case where the second decoded video 34 corresponding to the enhancement layer video cannot be prepared even when the video buffer is going to overflow, the display apparatus 150 displays the first decoded video 32 on the display 152 in place of the second decoded video 34, thereby avoiding breakdown of the displayed video. On the other hand, if the reception delay of the second multiplexed bitstream 39 with respect to the first multiplexed bitstream 38 is not so large as to make the video buffer overflow, the display apparatus 150 can display the second decoded video 34 corresponding to a high-quality enhancement layer video on the display 152. Note that the display apparatus 150 can continuously display the first decoded video 32 or the second decoded video 34 on the display 152 by controlling the displayed video using T even at the time of channel switching.

As described above, the video delivery system according to the second embodiment transmits a plurality of multiplexed bitstreams via a plurality of channels. For example, by transmitting a first multiplexed bitstream generated using an existing first codec via an existing first channel, an existing video playback apparatus can decode and play a base layer video. On the other hand, by transmitting a second multiplexed bitstream generated using a second codec different from the first codec via a second channel different from the first channel, a video playback apparatus (for example, video playback apparatus 600) that supports both the first codec and the second codec can decode and play an enhancement layer video having high quality (for example, high image quality, high resolution, and high frame rate). In addition, since the video compression apparatus controls the prediction structure of the second bitstream, as described above in the first embodiment, high random accessibility can be achieved, as in the first embodiment.

The video delivery system 100 according to the above-described first embodiment or the video delivery system 400 according to the second embodiment may use the adaptive streaming technique. In the adaptive streaming technique, a variation in the bandwidth of a channel is predicted, and the bitstream transmitted via the channel is switched based on the prediction result. According to the adaptive streaming technique, for example, quality of a video delivered for a web page is switched in accordance with the bandwidth, thereby continuously playing the video. According to scalable compression, the total code amount when a plurality of bitstreams are generated can be suppressed, and a variety of bitstreams can be generated at a high compression efficiency as compared to simultaneous compression. Hence, scalable compression is suitable for the adaptive streaming technique, as compared to simultaneous compression, particularly in a case where the variation in the bandwidth of the channel is large.

More specifically, the video compression apparatus 200 may generate the plurality of multiplexed bitstreams 27 using scalable compression and output them to the video transmission apparatus 120. Then, the video transmission apparatus 120 may predict the current bandwidth of a channel 130 and selectively transmit the multiplexed bitstream 27 according to the prediction result. When the video transmission apparatus 120 operates in this way, a dynamic encoding type adaptive streaming technique suitable for one-to-one video delivery can be implemented. Alternatively, the video receiving apparatus 140 may predict the current bandwidth of the channel 130 and request the video transmission apparatus 120 to transmit the multiplexed bitstream 27 according to the prediction result. When the video receiving apparatus 140 operates in this way, a pre-recorded type adaptive streaming technique suitable for one-to-many video delivery can be implemented. The dynamic encoding type adaptive streaming technique and the pre-recorded type adaptive streaming technique may be used in combination.

Similarly, the video compression apparatus 500 may generate the plurality of second multiplexed bitstreams 26 (or the plurality of first multiplexed bitstreams 25) using scalable compression and output them to the second video transmission apparatus 422 (or first video transmission apparatus 421). The second video transmission apparatus 422 may predict the current bandwidth of the second channel 432 (or first channel 431) and selectively transmit the second multiplexed bitstream 26 (or first multiplexed bitstream 25) according to the prediction result. When the second video transmission apparatus 422 operates in this way, a dynamic encoding type adaptive streaming technique can be implemented. Alternatively, the second video receiving apparatus 442 (or first video receiving apparatus 441) may predict the current bandwidth of the second channel 432 and request the second video transmission apparatus 422 to transmit the second multiplexed bitstream 26 according to the prediction result. When the second video receiving apparatus 442 operates in this way, a pre-recorded type adaptive streaming technique can be implemented. The dynamic encoding type adaptive streaming technique and the pre-recorded type adaptive streaming technique may be used in combination.

The video delivery system 100 according to the first embodiment may perform timing control such that the first bitstream 15 and the second bitstream 20 corresponding to pictures of the same time are transmitted from the video transmission apparatus 120 almost simultaneously. As described above, since each picture included in the second bitstream 20 is compressed after a corresponding picture included in the first bitstream 15 is compressed and decoded, the generation timing of the second bitstream 20 delays as compared to the first bitstream 15. Then, the data multiplexer 260 gives a delay of a first predetermined time to the first bitstream 15, thereby multiplexing the first bitstream 15 and the second bitstream 20 corresponding to pictures of the same time.

More specifically, a stream buffer configured to temporarily hold the first bitstream 15 and then transfer it to the subsequent processor may be added to the video compression apparatus 200 (data multiplexer 260). The first predetermined time is determined by the difference between the generation time of the first bitstream 15 corresponding to a given picture and the generation time of the second bitstream 20 corresponding to a picture of the same time as the given picture. With this timing control, although the transmission timing of the first bitstream 15 delays by the first predetermined time, the buffer needed in the video playback apparatus 300 can be reduced. The video delivery system 400 according to the second embodiment may also perform the same timing control.

Similarly, the video delivery system 100 according to the first embodiment or the video delivery system 400 according to the second embodiment may control the timing to display the first decoded video 32 and the second decoded video 34 on the display apparatus 150. As described above, since each picture included in the second bitstream 31 is decoded after a corresponding picture included in the first bitstream 30 is decoded, the generation timing of the second decoded video 34 delays as compared to the first decoded video 32. Then, for example, the video buffer prepared in the display apparatus 150 gives a delay of a second predetermined time to the first decoded video 32. The second predetermined time is determined by the difference between the generation time of the first decoded video 32 corresponding to a given picture and the generation time of the second decoded video 34 corresponding to a picture of the same time as the given picture.

The two types of timing control described here are useful to absorb a processing delay, transmission delay, display delay, and the like and continuously display a high-quality video. However, if these delays are very small, the timing control may be omitted. Generally, in a video delivery system that transmits a bitstream in real time, various buffers such as a stream buffer to correctly decode the bitstream, a video buffer to correctly play a decoded video, a buffer for transmission and reception of the bitstream, and an internal buffer of the display apparatus are prepared. The above-described delay circuits 231 and 332 and the delay circuit that gives the delays of the first predetermined time and second predetermined time can be implemented using these buffers or prepared independently of these buffers.

Note that in the above description of the first and second embodiments, two types of bitstreams are generated. However, three or more types of bitstreams may be generated. In addition, when three or more types of bitstreams may be generated, various hierarchical structures can be employed. For example, a three-layer structure including a base layer, a first enhancement layer, and a second enhancement layer above the first enhancement layer may be employed. Double two-layer structures including a base layer, a first enhancement layer, and a second enhancement layer of the same level as the first enhancement layer may be employed. Generating a plurality of enhancement layers of different levels makes it possible to, for example, more flexibly adapt to a variation in the bandwidth when using the adaptive streaming technique. On the other hand, generating a plurality of enhancement layers of the same level is suitable for, for example, ROI (Region Of Interest) compression that assigns a large code amount to a specific region in a frame. More specifically, by setting different ROIs for the plurality of enhancement layers, image quality of ROI according to a user request can preferentially be increased, as compared to other regions. Alternatively, the plurality of enhancement layers may perform different scalabilities. For example, the first enhancement layer may implement PSNR scalability, and the second enhancement layer may implement resolution scalability. The larger the number of enhancement layers is, the higher the device cost is. However, since the bitstream to be transmitted can be selected more flexibly, the transmission band can be used more effectively.

The video compression apparatus and the video playback apparatus described in the above embodiments can be implemented using hardware such as a CPU, LSI (Large-Scale Integration) chip, DSP (Digital Signal Processor), FPGA (Field Programmable Gate Array), or GPU (Graphics Processing Unit). The video compression apparatus and the video playback apparatus can also be implemented by, for example, causing a processor such as a CPU to execute a program (that is, by software).

At least a part of the processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video compression apparatus comprising:
a first compressor that compresses, out of a first video and a second video that are layered, the first video using a first codec to generate a first bitstream;
a controller that controls, based on a first random access point included in the first bitstream, a second random access point included in a second bitstream corresponding to compressed data of the second video; and
a second compressor that compresses the second video using a second codec different from the first codec based on a first decoded video corresponding to the first video to generate the second bitstream,
wherein the second bitstream is formed from a plurality of picture groups,
each of the plurality of picture groups includes at least one picture subgroup, and
the controller selects, from the second bitstream, an earliest picture subgroup on or after the first random access point in display order and sets an earliest picture of the selected picture subgroup in coding order as the second random access point.

2. The apparatus according to claim 1, wherein
the picture subgroup corresponds to a picture sequence having a first reference relationship,
the picture group corresponds to a picture sequence having a second reference relationship, and
the second reference relationship is represented by a combination of at least one first reference relationship associated with at least one picture subgroup included in the picture group.

3. The apparatus according to claim 1, further comprising a converter that applies video conversion to the first decoded video to make a video format of the first decoded video match a video format of the second video.

4. The apparatus according to claim 3, wherein the converter applies, to the first decoded video, at least one of (a) processing of changing a resolution of the first decoded video, (b) processing of converting the first decoded video to one of an interlaced video and a progressive video, (c) processing of changing a frame rate of the first decoded video, (d) processing of changing a bit depth of the first decoded video, (e) processing of changing a color space format of the first decoded video, (f) processing of changing a dynamic range of the first decoded video, and (g) processing of changing an aspect ratio of the first decoded video.

5. The apparatus according to claim 4, wherein the first video is the interlaced video,
the first bitstream includes information representing a phase of the first video,
the second video is the progressive video, and
the converter performs the processing of converting the first decoded video to the progressive video based on the information representing the phase of the first video.

6. The apparatus according to claim 1, further comprising a multiplexer that multiplexes the first bitstream and the second bitstream to generate a multiplexed bitstream,
wherein the multiplexed bitstream is transmitted via a channel.

7. The apparatus according to claim 6, wherein the multiplexer generates, based on a video synchronizing signal representing a playback timing of a baseband video corresponding to the first video and the second video, reference information representing a reference clock value used to synchronize a first system clock incorporated in a video playback apparatus with a second system clock incorporated in the video compression apparatus, and synchronizing information representing one of a playback time and a decoding time of the first bitstream and the second bitstream in terms of the second system clock, and multiplexes the first bitstream, the second bitstream, the reference information, and the synchronizing information to generate the multiplexed bitstream.

8. The apparatus according to claim 6, wherein the multiplexer temporarily holds the first bitstream and multiplexes the held first bitstream and the second bitstream.

9. The apparatus according to claim 1, further comprising:
a first multiplexer that multiplexes the first bitstream to generate a first multiplexed bitstream; and
a second multiplexer that multiplexes the second bitstream to generate a second multiplexed bitstream,
wherein the first multiplexed bitstream is transmitted via a first channel, and
the second multiplexed bitstream is transmitted via a second channel different from the first channel.

10. The apparatus according to claim 9, wherein the first channel is a channel with a band guarantee, and
the second channel is a channel without a band guarantee.

11. The apparatus according to claim 1, wherein the first codec is one of MPEG-2, MPEG-4, H.264/AVC, and HEVC, and
the second codec is a scalable extension of HEVC.

12. The apparatus according to claim 1, wherein the first bitstream includes at least one of information representing that the first video is one of a progressive video and an interlaced video, information representing a phase of the first video as the interlaced video, information representing a frame rate of the first video, information representing a resolution of the first video, information representing a bit depth of the first video, information representing a color space format of the first video, and information representing the first codec, and
the second bitstream includes at least one of information representing that the second video is one of a progressive video and an interlaced video, information representing a phase of the second video as the interlaced video, information representing a frame rate of the second video, information representing a resolution of the second video, information representing a bit depth of the second video, information representing a color space format of the second video, and information representing the second codec.

13. The apparatus according to claim 1, further comprising a decoder that decodes the first bitstream using the first codec to generate the first decoded video,
wherein if a decoding order and a display order of decoded pictures included in the first decoded video do not match, the decoder outputs the decoded pictures in accordance with the decoding order.

14. The apparatus according to claim 1, wherein the second compressor describes, in the second bitstream, information representing that a picture corresponding to the second random access point is random-accessible.

15. The apparatus according to claim 1, wherein the second compressor compresses a picture corresponding to the second random access point using a prediction mode other than inter-frame prediction.

16. A video playback apparatus comprising:
a first decoder that decodes, using a first codec, a first bitstream corresponding to compressed data of a first video out of the first video and a second video that are layered, to generate a first decoded video; and
a second decoder that decodes a second bitstream corresponding to compressed data of the second video using a second codec different from the first codec based on the first decoded video to generate a second decoded video,
wherein the second bitstream is formed from a plurality of picture groups,
each of the plurality of picture groups includes at least one picture subgroup,
the first bitstream includes a first random access point,
the second bitstream includes a second random access point,
the second random access point is set to an earliest picture of a particular picture subgroup in coding order, and
the particular picture subgroup is an earliest picture subgroup on or after the first random access point in display order.

17. The apparatus according to claim 16, wherein the first bitstream is transmitted via a first channel,
the second bitstream is transmitted via a second channel different from the first channel, and
if a delay time of a second reception time of the second bitstream with respect to a first reception time of the first bitstream reaches a predetermined time length, the first decoded video is output as a display video in place of the second decoded video.

18. The apparatus according to claim 16, wherein if a decoding order and a display order of decoded pictures included in the first decoded video do not match, the first decoder outputs the decoded pictures in accordance with the decoding order.

19. The apparatus according to claim 16, further comprising:
a demultiplexer that demultiplexes a multiplexed bitstream to generate the first bitstream and the second bitstream; and
a delay circuit that temporarily holds the second bitstream and transfers the held second bitstream to the second decoder.

20. A video delivery system comprising:
a video storage apparatus that stores and reproduces a baseband video;
a video compression apparatus that scalably-compresses a first video and a second video in which the baseband video is layered, to generate a first bitstream and a second bitstream;
a video transmission apparatus that transmits the first bitstream and the second bitstream via at least one channel;
a video receiving apparatus that receives the first bitstream and the second bitstream via the at least one channel;
a video playback apparatus that scalably-decodes the first bitstream and the second bitstream to generate a first decoded video and a second decoded video; and
a display apparatus that displays a video based on the first decoded video and the second decoded video,
wherein the video compression apparatus comprises:
a first compressor that compresses the first video using a first codec to generate the first bitstream;
a controller that controls, based on a first random access point included in the first bitstream, a second random access point included in the second bitstream; and
a second compressor that compresses the second video using a second codec different from the first codec based on the first decoded video corresponding to the first video to generate the second bitstream,
wherein the second bitstream is formed from a plurality of picture groups,
each of the plurality of picture groups includes at least one picture subgroup, and
the controller selects, from the second bitstream, an earliest picture subgroup on or after the first random access point in display order and sets an earliest picture of the selected picture subgroup in coding order as the second random access point.
